(19) United States
(12) Patent Application Publication
(10) Pub. No.: US 2007/0279957 A1
(43) Pub. Date: Dec. 6, 2007

(54) POWER INTEGRATED CIRCUIT

(76) Inventors: Hiromichi OOHASHI, Tsukuba-shi (JP); Yuusuke HAYASHI, Tsukuba-shi (JP); Tatsuto KINJOU, Tsukuba-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 11/757,640

(22) Filed: Jun. 4, 2007

(30) Foreign Application Priority Data
Jun. 5, 2006 (JP) 2006-156701

(51) Int. Cl. H02M 7/5387

(52) U.S. Cl. 363/132

(57) ABSTRACT

In a power integrated circuit, a voltage-type single-phase full-bridge conversion circuit is used as a basic unit. The basic unit includes a level-shift-type gate drive circuit. An integrated single-phase multi-level conversion circuit is formed by connecting basic units in series. An integrated three-phase multi-level conversion circuit is formed by connecting three basic units in parallel or by connecting three sets of serially connected basic units in parallel. Since the output multi-level voltage waveform of the integrated single-phase or three-phase multi-level conversion circuit is low in harmonic content, it can constitute a single-phase or three-phase power converter without use of a passive filter.

### BACKGROUND OF THE INVENTION

1. Field of the Invention

The present invention relates to an integrated circuit of a power converter, and more particularly to a power integrated circuit which enables densification of a power converter through elimination of passive filters.

2. Description of the Related Art

FIGS. 31A and 31B are diagrams of conventional voltage-type 2-level conversion circuits, wherein FIG. 31A shows a conversion circuit for single-phase output, and FIG. 31B shows a conversion circuit for three-phase output. In the circuit shown in FIG. 31A, four semiconductor devices which constitute a single-phase bridge circuit are alternately switched to two levels; i.e., on and off states, and a passive filter is connected to an output of the bridge circuit so as to obtain a single-phase AC output voltage. Similarly, in the circuit shown in FIG. 31B, six semiconductor devices which constitute a three-phase bridge circuit are alternately switched to two levels; i.e., on and off states, and a passive filter is connected to an output of the bridge circuit so as to obtain a three-phase AC output voltage. Conventionally, power density of a power converter constituted by such a voltage-type 2-level conversion circuit has been achieved through reduction of its volume. This volume reduction has been achieved by two fundamental methods; i.e., (1) reducing loss of a power conversion apparatus to thereby reduce the volume of a cooling unit, and (2) increasing switching frequency to thereby reduce the volume of passive components such as an LC filter shown in FIG. 32. However, such an LC filter is indispensable in a 2-level conversion apparatus, and an increase in the switching frequency causes an increase in switching loss generated as a result of switching of semiconductor devices, leading to increased size of the cooling unit. Therefore, there is a limit on power densification. Further, a high switching frequency causes generation of induction voltage stemming from a parasitic inductance of main circuit wiring and displacement current stemming from a parasitic capacitance of the main circuit wiring, to thereby increase the loss of semiconductor devices and generate radiation noise. In conversion circuits for signal transmission, such as LSIs, since voltage and current to be handled are very small, they can be operated at high frequency. In contrast, in power conversion circuits for energy transmission, since voltage and current to be handled are large, radiation/conduction noise generated as a result of high frequency operation cause various problems, such as erroneous operation of gate drive circuits. Therefore, there is a need for a high-power-density power conversion circuit which can eliminate LC filters and reduce loss of semiconductor devices, without increasing switching frequency.

FIGS. 33A to 41 show multi-level conversion circuits which can eliminate LC filters without increasing switching frequency and each of which has an increased number m of levels to thereby reduce the harmonic content of the output voltage. The harmonics of the output voltage of a multi-level conversion circuit decrease as the number of levels increases. In the case of a 17-level converter, since the total distortion factor of the output voltage is 5% or less, no LC filter is required. However, since such 17-level converter requires 96 semiconductor devices and 96 inverse-parallel diodes, the sizes of the converter main circuit and the gate drive circuit become excessively large, and implementation of the converter becomes difficult.

FIGS. 33A to 38 show the configurations of conventional cascade-type multi-level conversion circuits, wherein FIGS. 33A and 33B show voltage-type 3-level conversion circuits; FIGS. 34A and 34B show voltage-type 4-level and 5-level conversion circuits; FIG. 35 shows a voltage-type single-phase m-level conversion circuit, where m is an odd number; FIG. 36 shows a voltage-type three-phase m-level conversion circuit, where m is an odd number; FIG. 37 shows a voltage-type single-phase m-level conversion circuit, where m is an even number; and FIG. 38 shows a voltage-type three-phase m-level conversion circuit, where m is an even number. FIGS. 39 to 41 show the configurations of conventional diode-clamp-type multi-level conversion circuits, wherein FIG. 39 shows a voltage-type 3-level conversion circuit; FIG. 40 shows a voltage-type single-phase m-level conversion circuit; and FIG. 41 shows a voltage-type three-phase m-level conversion circuit.

In the cases of FIGS. 35 and 36 in which the number m of levels is an odd number, for a level conversion circuit having an arbitrary odd number of levels, the number of serially connected basic units for each phase is defined as follows. When the number of levels is 3, the number of serially connected basic units for each phase is one ((3−1)/2=1). When the number of levels is 5, the number of serially connected basic units for each phase is two ((5−1)/2=2). When the number of levels is 17, the number of serially connected basic units for each phase is eight ((17−1)/2=8). In the cases of FIGS. 37 and 38 in which the number m of levels is an even number, for a level conversion circuit having an arbitrary even number of levels, the number of serially connected basic units for each phase is defined as follows. When the number of levels is 2, the number of serially connected basic units for each phase is one (2/2=1). When the number of levels is 4, the number of serially connected basic units for each phase is two (4/2=2). When the number of levels is 18, the number of serially connected basic units for each phase is nine (18/2=9). In the cases of m-level conversion circuits of FIGS. 40 and 41, for a level conversion circuit having an arbitrary number of levels, the number of switching semiconductor devices for each phase is defined as follows. When the number of levels is 3, the number of switching semiconductor devices for each phase is four ((3−1)×2=4) (the number of switching semiconductor devices in the upper arm is two (3−1=2)). When the number of levels is 4, the number of switching semiconductor devices for each phase is six ((4−1)×2=6) (the number of switching semiconductor devices in the upper arm is three (4−1=3)). When the number of levels is 5, the number of switching semiconductor devices for each phase is eight ((5−1)×2=8) (the number of switching semiconductor devices in the upper arm is four (5−1=4)).

In the case of cascade-type multi-level conversion circuits shown in FIGS. 33A to 38, the number of DC power sources increases with the number of levels. That is, 3-level conversion circuits require one DC power source for each phase as shown in FIGS. 33A and 33B; 5-level conversion circuits require two DC power sources for each phase; and m-level conversion circuits require (m−1)/2 DC power sources for each phase. This is a drawback of the cascade-type multi-level conversion circuits.

In the case of diode-clamp-type multi-level conversion circuits shown in FIGS. 39 to 41, a gate drive circuit must be individually provided for each switching semiconductor device. Therefore, the number of gate drive circuits increases with the number of levels. That is, the 3-level conversion circuit shown in FIG. 39 requires four gate drive circuits for each phase; and the m-level conversion circuits shown in FIGS. 40 and 41 each require (m−1)×2 gate drive circuits for each phase. This is a drawback of the diode-clamp-type multi-level conversion circuits. Since the large number of gate drive circuits hinders integration of the above-mentioned multi-level conversion circuits, a new circuit scheme which reduces the number of gate drive circuits is required.

One-chip power ICs and intelligent power modules (IPMs) utilizing LSI technologies have been developed and applied in various fields. An integrated 2-level conversion circuit including gate drive circuits utilizing the above-described techniques has been proposed (see the following literatures); however, a power integrated circuit for multi-level converters has not yet been proposed.

Y. Hayashi, K. Takao, K. Adachi, and H. Ohashi, “Design Consideration for High Output Power Density (OPD) Converter Based on Power-Loss Limit Analysis Method,” in Proc. CD-ROM, EPE, 2005.

M. Tsukuda, I. Omura, W. Saito, and T. Ogura, “Demonstration of High Output Power Density (30 W/cc) Converter using 600 V SiC-SBD and Low Impedance Gate Driver,” in Proc. CD-ROM, IPEC Niigata, 2005.

### SUMMARY OF THE INVENTION

In a high-density power conversion apparatus using the above-described 2-level converter, the sizes of filters are reduced by increasing switching frequency, which increases switching loss generated as a result of switching of semiconductor devices. Therefore, there is a limit on densification of power converters.

In order to solve the above-described problem, the present invention realizes a high-density power converter which is designed from a viewpoint completely different from those of the above-described conventional converters; i.e., which can downsize filters without increasing switching frequency. Thus, the present invention enables a high-density power converter to be fabricated in the form of an integrated circuit.

In order to solve the above-described problem and achieve the above-described object, the present invention provides a power integrated circuit of a multi-level conversion circuit in which a voltage-type single-phase full-bridge circuit is integrated as a basic unit of the multi-level conversion circuit, an integrated single-phase m-level conversion circuit is formed by connecting the basic units in series, and three integrated single-phase m-level conversion circuits are connected in parallel so as to form an integrated three-phase m-level conversion circuit.

The present invention also provides a power integrated circuit in which the base unit includes a level-shift-type gate drive circuit configured such that when a low-voltage-side gate drive circuit is off, drive energy is supplied to a high-voltage-side gate drive circuit via a diode.

The present invention also provides an integrated multi-level AC-DC-AC conversion circuit in which integrated multi-level conversion circuits are symmetrically connected via a DC section which includes (m−1)/2 or m/2 DC-link capacitors in order to eliminate a DC power source used in the cascade multi-level conversion circuit scheme.

The present invention also provides a power integrated circuit in which positive and negative terminals of gate drive circuits in the first basic unit to the odd-order-(m−1)/2-th or the even-order-m/2-th basic unit for each phase are connected as common terminals so as to reduce the number of wiring lines.

The present invention also provides a power integrated circuit formed of a diode-clamp-type multi-level conversion circuit. When a turn on signal is input to upper-arm semiconductor devices in accordance with a switching pattern in the diode-clamp-type multi-level conversion circuit, a turn off signal is input to lower-arm semiconductor devices. Therefore, each of semiconductor devices in the upper arms for a single phase or three phases is formed of a p-channel MOSFET, and each of semiconductor devices in the lower arms for a single phase or three phases is formed of a n-channel MOSFET. When turn-on drive energy is supplied from the gate drive circuit, the upper arm p-channel MOSFETs are turned off, and the lower arm n-channel MOSFETs are turned on. When turn-off drive energy is supplied from the gate drive circuit, the upper arm p-channel MOSFETs are turned on, and the lower arm n-channel MOSFETs are turned off. One gate drive circuit is provided for each pair including a p-channel MOSFET and an n-channel MOSFET.

According to the present invention, a basic unit including a level-shift-type gate drive circuit is formed as an integrated circuit of a voltage-type single-phase full-bridge circuit. Therefore, an integrated single-phase multi-level conversion circuit can be readily realized through serial connection of the basic units.

Further, according to the present invention, an integrated three-phase multi-level conversion circuit can be readily realized through parallel connection of the single-phase multi-level conversion circuits each formed through serial connection of the basic units. According to the present invention, in a cascade multi-level conversion circuit, integrated (m−1)/2-level conversion circuits are symmetrically connected via a DC section which includes (m−1)/2 DC-link capacitors, whereby an integrated (m−1)/2-level AC-DC-AC conversion circuit is formed. Therefore, a DC power source can be eliminated.

According to the present invention, in an integrated multi-level conversion circuit, positive and negative terminals of gate drive circuits in the first basic unit to the odd-order-(m−1)/2-th or the even-order-m/2-th basic unit for each phase are connected as common terminals. Therefore, the number of wiring lines can be reduced.

According to the present invention, in an integrated three-phase multi-level conversion circuit, the positive and negative terminals of the first basic units for respective phases are connected as common terminals, and the positive and negative terminals of the odd-order-(m−1)/2-th or the even-order-m/2-th basic units for respective phases are connected as common terminals. Therefore, the number of wiring lines can be reduced.

According to the present invention, in a diode-clamp-type multi-level conversion circuit, one gate drive circuit is provided for each pair including a p-channel MOSFET and an n-channel MOSFET. Therefore, the number of gate drive circuits can be halved as compared with the conventional gate drive scheme.

Synergetic effects can be expected. That is, because of downsizing of the wiring of the main circuit through integration, parasitic inductance and capacitance can reduced, and because of low switching frequency, noise of the conversion circuit can be reduced.

The multi-level conversion circuit is low in switching frequency, and hardly generates switching loss. Therefore, the volume of a cooling unit can be reduced, whereby a high-density power converter can be realized.

In a drive scheme for AC motor drive in which a 2-level converter is used, velocity control and torque control are performed in addition to pulse width modulation. However, such a drive scheme has drawbacks in that the harmonic content is high, and torque vibration is generated in the vicinity of the switching frequency. In contrast, the output voltage waveform of the multi-level converter is low in harmonic content, and velocity control and torque control are performed without increasing the switching frequency, so that torque variation is small. Therefore, as compared with the 2-level converter, the multi-level converter has advantageous effects such as reduction of shaft friction and elongation of service life.

### BRIEF DESCRIPTION OF THE DRAWINGS

FIG. 1 is a power integrated circuit which uses a single-phase voltage-type full-bridge circuit as a basic unit and which includes a level-shift-type gate drive circuit;

FIG. 2 is an integrated three-phase odd-number-m-level conversion circuit, in which three single-phase odd-number-m-level conversion circuits are connected in parallel;

FIG. 3 is an integrated three-phase even-number-m-level conversion circuit, in which three single-phase even-number-m-level conversion circuits are connected in parallel;

FIG. 4 is an integrated single-phase odd-number-m-level conversion circuit in which (m−1)/2 basic units are connected in series;

FIG. 5 is an integrated single-phase even-number-m-level conversion circuit in which m/2 basic units are connected in series;

FIG. 6 is an integrated three-phase odd-number-m-level AC-DC-AC conversion circuit which uses integrated three-phase odd-number-m-level conversion circuits;

FIG. 7 is an integrated three-phase even-number-m-level AC-DC-AC conversion circuit which uses integrated three-phase even-number-m-level conversion circuits;

FIG. 8 is an integrated single-phase odd-number-m-level AC-DC-AC conversion circuit which uses integrated single-phase odd-number-m-level conversion circuits;

FIG. 9 is an integrated single-phase even-number-m-level AC-DC-AC conversion circuit which uses integrated single-phase even-number-m-level conversion circuits;

FIG. 10 is an integrated single-phase m-level conversion circuit which includes combined p-channel MOSFETs and n-channel MOSFETs;

FIG. 11 is an integrated three-phase m-level conversion circuit which includes combined p-channel MOSFETs and n-channel MOSFETs;

FIG. 12 is an integrated single-phase 4-level/5-level conversion circuit in which two basic units are connected in series;

FIG. 13 is an integrated single-phase 6-level/7-level conversion circuit in which three basic units are connected in series;

FIG. 14 is an integrated three-phase 3-level conversion circuit in which three basic units are connected in parallel;

FIG. 15 is an integrated three-phase 4-level/5-level conversion circuit in which three single-phase 4-level/5-level conversion circuits are connected in parallel;

FIG. 16 is an integrated three-phase 6-level/7-level conversion circuit in which three single-phase 6-level/7-level conversion circuits are connected in parallel;

FIG. 17 is an integrated single-phase 3-level AC-DC-AC conversion circuit which uses integrated single-phase 3-level conversion circuits;

FIG. 18 is an integrated single-phase 4-level/5-level AC-DC-AC conversion circuit which uses integrated single-phase 4-level/5-level conversion circuits;

FIG. 19 is an integrated single-phase 6-level/7-level AC-DC-AC conversion circuit which uses integrated single-phase 6-level/7-level conversion circuits;

FIG. 20 is an integrated three-phase 3-level AC-DC-AC conversion circuit which uses integrated three-phase 3-level conversion circuits;

FIG. 21 is an integrated three-phase 4-level/5-level AC-DC-AC conversion circuit which uses integrated three-phase 4-level/5-level conversion circuits;

FIG. 22 is an integrated three-phase 6-level/7-level AC-DC-AC conversion circuit which uses integrated three-phase 6-level/7-level conversion circuits;

FIG. 23 is an integrated single-phase 3-level conversion circuit which includes combined p-channel MOSFETs and n-channel MOSFETs;

FIG. 24 is an integrated single-phase 4-level conversion circuit which includes combined p-channel MOSFETs and n-channel MOSFETs;

FIG. 25 is an integrated single-phase 5-level conversion circuit which includes combined p-channel MOSFETs and n-channel MOSFETs;

FIG. 26 is an integrated three-phase 3-level conversion circuit which includes combined p-channel MOSFETs and n-channel MOSFETs;

FIG. 27 is an integrated three-phase 4-level conversion circuit which includes combined p-channel MOSFETs and n-channel MOSFETs;

FIG. 28 is an integrated three-phase 5-level conversion circuit which includes combined p-channel MOSFETs and n-channel MOSFETs;

FIG. 29 is an external view showing the outer shape of an integrated three-phase 17-level power converter;

FIG. 30 is an external view showing the outer shape of the integrated three-phase 17-level power converter and that of a 3 kW motor for comparison of their volumes;

FIG. 31 is a diagram of a conventional 2-level conversion circuit;

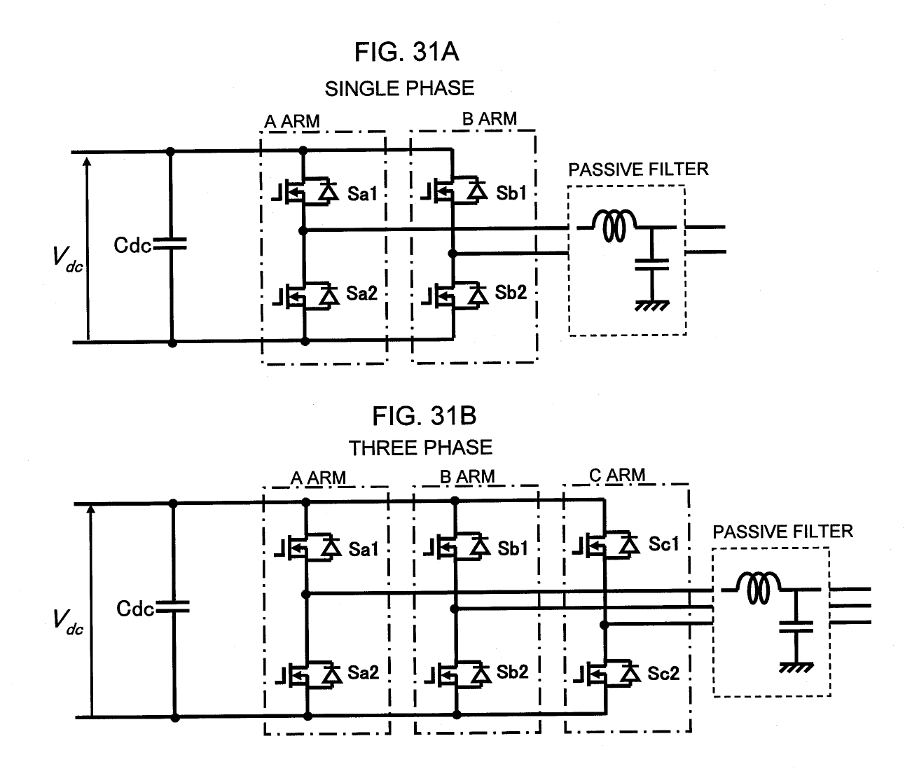

FIG. 32 is a diagram of a passive filter;

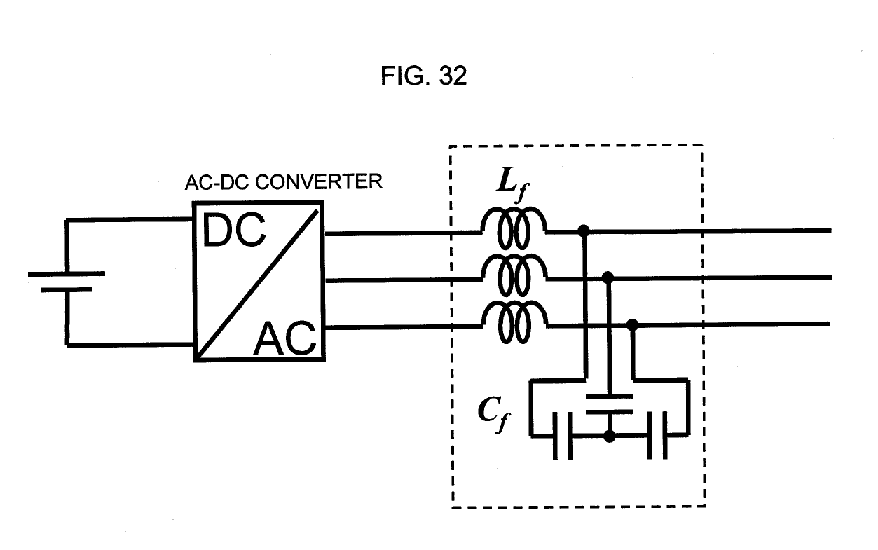

FIGS. 33A and 33B are diagrams of conventional cascade, voltage-type 3-level conversion circuits;

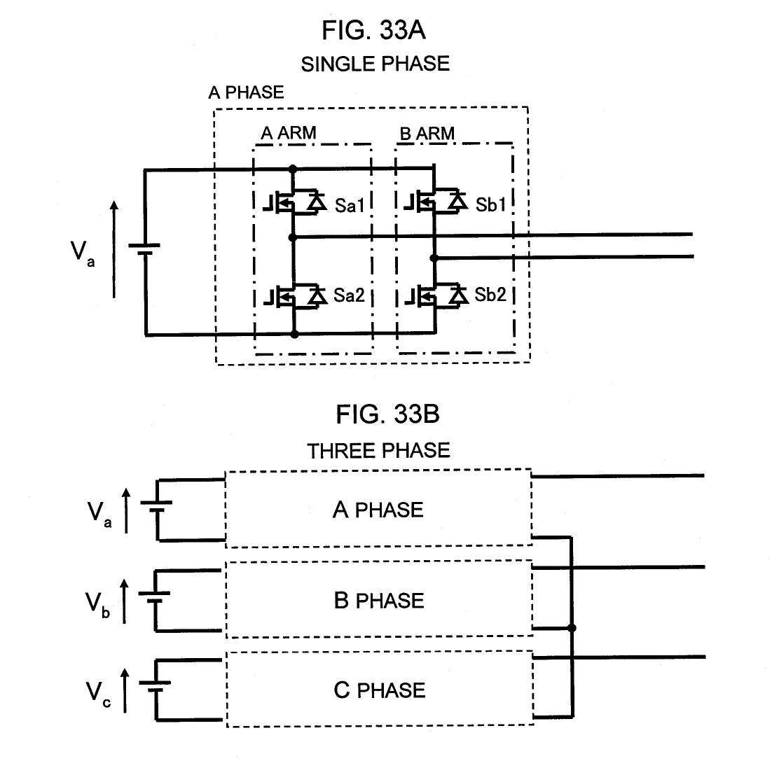

FIGS. 34A and 34B are diagrams of conventional cascade, voltage-type 4-level/5-level conversion circuits;

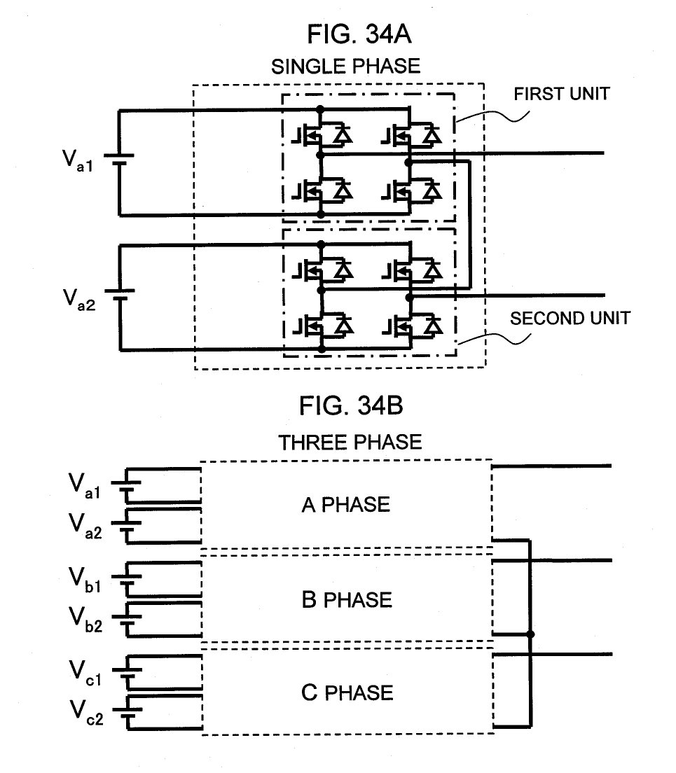

FIG. 35 is a diagram of a conventional cascade, voltage-type single-phase odd-number-m-level conversion circuit;

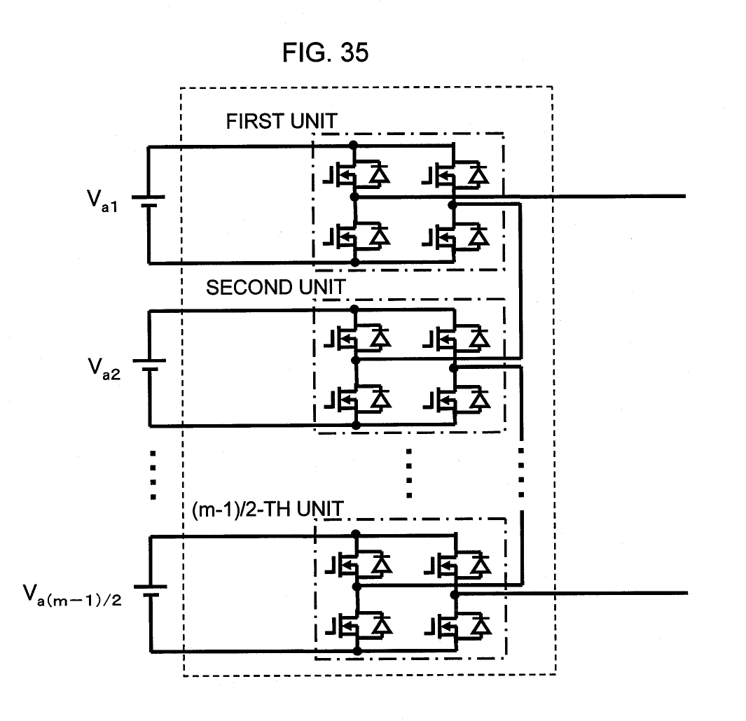

FIG. 36 is a diagram of a conventional cascade, voltage-type three-phase odd-number-m-level conversion circuit;

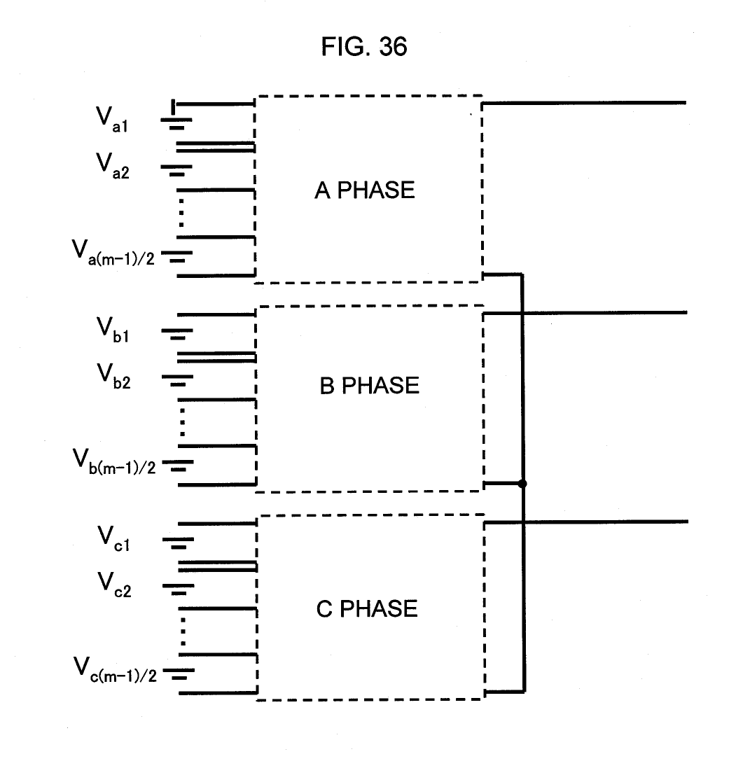

FIG. 37 is a diagram of a conventional cascade, voltage-type single-phase even-number-m-level conversion circuit;

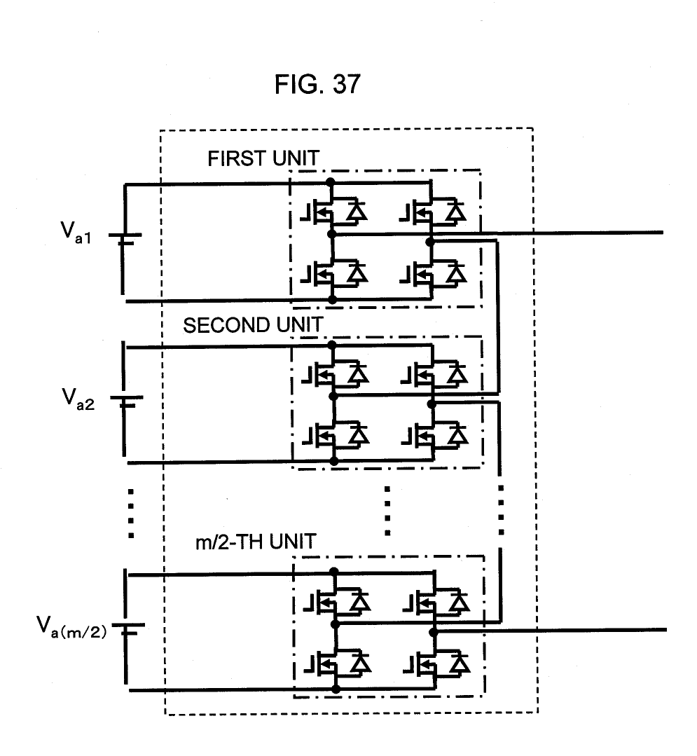

FIG. 38 is a diagram of a conventional cascade, voltage-type three-phase even-number-m-level conversion circuit;

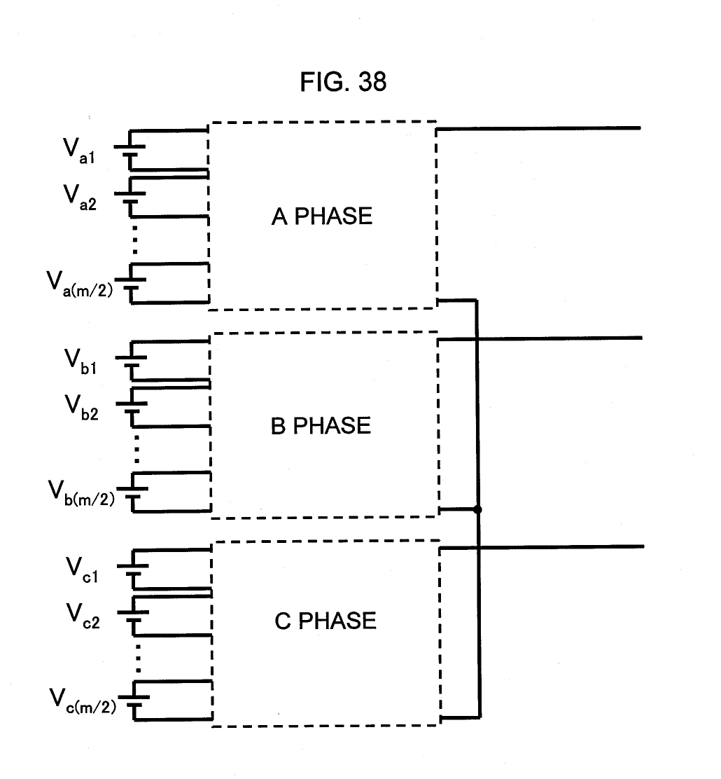

FIG. 39 is a diagram of a conventional diode-clamp, voltage-type 3-level conversion circuit;

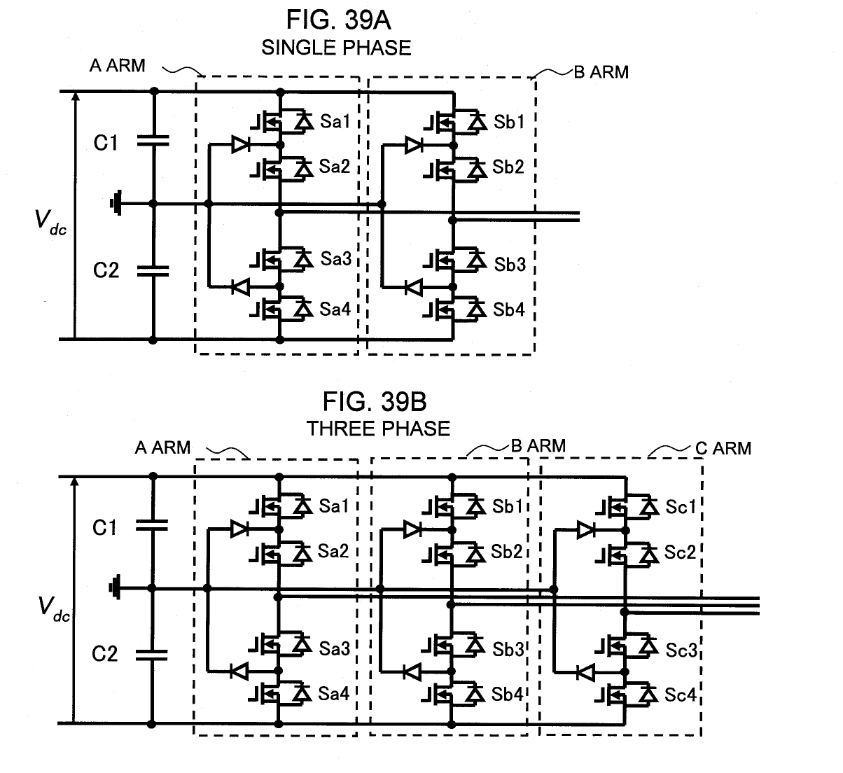

FIG. 40 is a diagram of a conventional diode-clamp, voltage-type single-phase m-level conversion circuit;

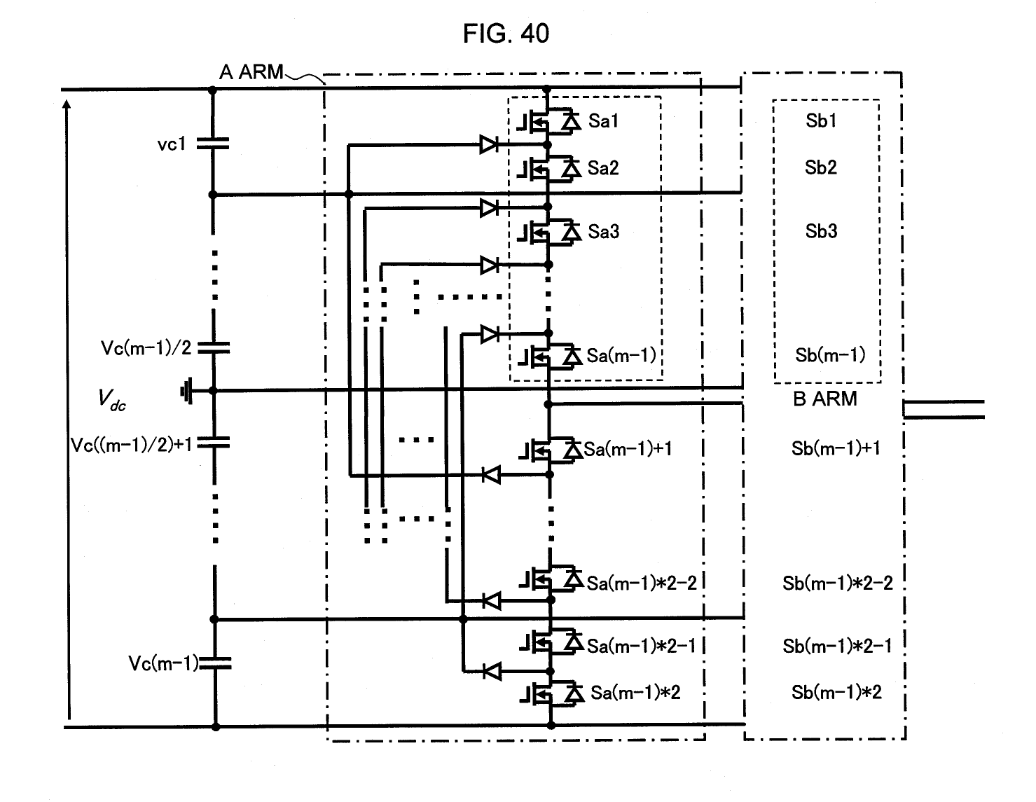

FIG. 41 is a diagram of a conventional diode-clamp, voltage-type three-phase m-level conversion circuit;

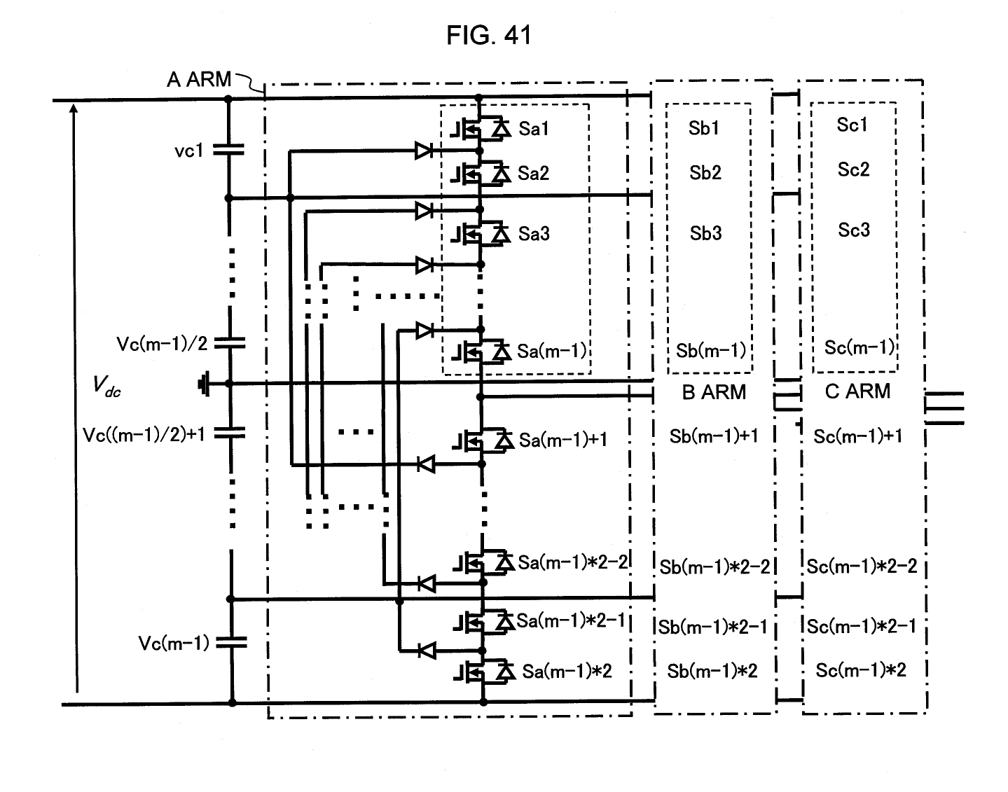

FIG. 42 is a flowchart showing a process of designing an integrated multi-level converter;

FIG. 43 shows application of the integrated multi-level converter to a motor;

FIG. 44 shows application of the integrated multi-level converter to system interconnection;

FIG. 45 is a detailed diagram of an integrated multi-level basic unit;

FIG. 46 is a cross sectional view of the basic unit;

FIG. 47 shows the structure of a capacitor for a drive power source;

FIG. 48 is a view of an integrated multi-level converter chip; and

FIG. 49 is a view of the integrated multi-level converter.

### DETAILED DESCRIPTION OF THE PREFERRED EMBODIMENTS

Power converters according to the present invention will be described, while DC-AC converters for conversion from DC to AC are taken as examples; however, the present invention is not limited thereto, and can be applied to AC-DC converters for conversion from AC to DC.

### First Embodiment

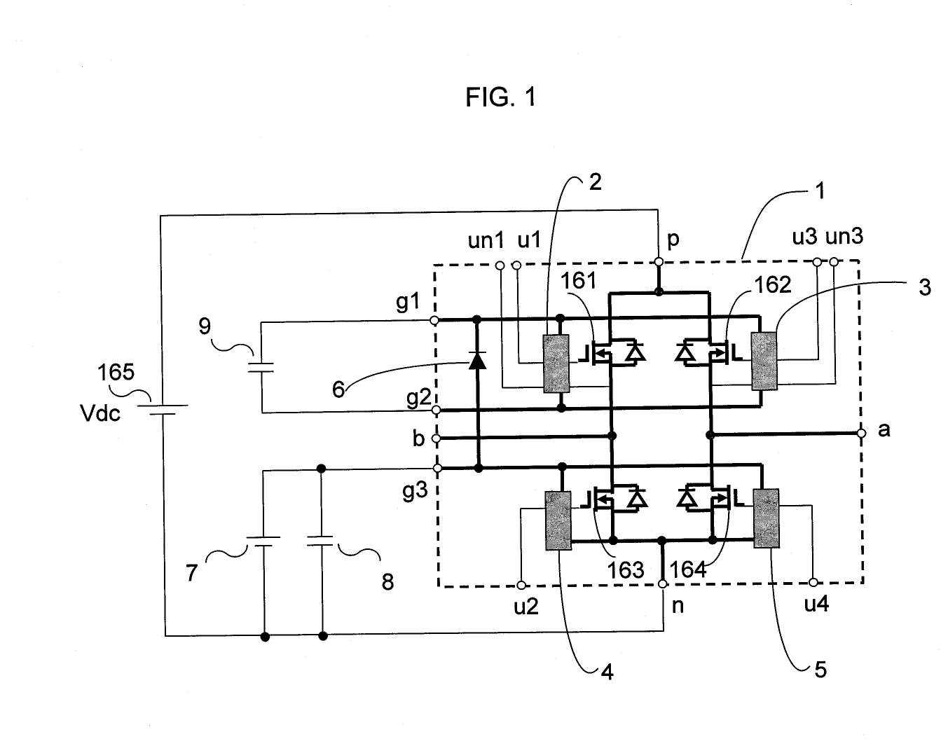

A first embodiment of the present invention will be described in detail with reference to the drawings. FIG. 1 shows a power integrated circuit which includes a voltage-type single-phase full-bridge circuit as a basic unit 1. As shown in FIG. 1, one AC terminal of the basic unit 1 is disposed on one side as an output terminal a, and the other AC terminal of the basic unit 1 is disposed on the other side as a ground terminal b. The positive DC terminal of the basic unit 1 is disposed on the upper side as a positive terminal p, and the negative DC terminal of the basic unit 1 is disposed on the lower side as a negative terminal n. The power integrated circuit includes a level-shift-type gate circuit for gate drive of semiconductor devices of the basic unit 1. The level-shift-type gate circuit is designed in such a manner that when low-voltage-side gate drive circuits 4 and 5 are off, drive energy is supplied to high-voltage-side gate drive circuits 2 and 3 via a diode 6. The level-shift-type gate circuit drives the semiconductor devices of the basic unit 1 in cooperation with a single DC power source 7 and two external capacitors 8 and 9 connected thereto. The basic unit 1 forms an integrated single-phase 3-level conversion circuit. u1, un1, u2, u3, un3, and u4 denote signal lines for the semiconductor devices of the basic unit 1. Since the main semiconductor devices in the upper arms float with respect to the ground, the corresponding signal lines (of signal generators) must include ground-side signal lines which are maintained at a reference potential with respect to the ground, and therefore the upper arms require signal lines un1 and un3. In the case of the lower arms, since the ground of the main circuit serves as the ground for the signal lines, ground-side signal lines u2n and u4n can be omitted. Accordingly, in the upper arms, the paired signal lines u1 and un1 are used to drive a main semiconductor device 161, and the paired signal lines u3 and un3 are used to drive a main semiconductor device 162.

The illustrated level-shit-type gate drive circuit itself is conventionally used in voltage-type 2-level conversion circuits. The present invention provides an integrating method and a combining method which are suitably used when gate drive circuits conventionally used in 2-level conversion circuits are connected to a main circuit composed of semiconductor devices for integration and which can easily increase the number of levels of the multi-level converter through improved device arrangement and wiring of the main circuit and the gate drive circuits.

Since the wiring lines of the main circuit may have high electrical potentials, a wiring structure in which the wiring lines overlap each other is not suitable for integration (although an insulating technique enables such overlapping of the wiring lines, the chip volume becomes excessively large). In view of the above, as shown in the basic unit 1 of FIG. 1, the main circuit wiring lines and the gate drive circuits therearound are arranged such that the wiring lines do not overlap. Further, the device arrangement and wiring structure are determined such that integration is not hindered even when several basic units are connected in series and/or in parallel.

In the basic unit 1 of FIG. 1, the high-voltage-side gate drive circuits share common positive and negative DC terminals. Therefore, as shown in FIG. 1, the basic unit 1 has a wiring structure such that the positive and negative terminals are formed as common wiring lines. Further, the low-voltage-side gate drive circuits share common positive and negative DC terminals, the basic unit 1 has a wiring structure such that the positive and negative terminals are formed as common wiring lines.

The operation principle of the basic unit 1 of FIG. 1 will be described. In the high-voltage-side gate drive circuits of the basic unit, when the high-voltage-side main semiconductor devices 161 and 162 are turned on, gate drive energy is supplied from the external capacitor 9, and when the high-voltage-side main semiconductor devices 161 and 162 are turned off, the diode 6 is biased in the forward direction, and gate drive energy is supplied from the gate power source 7 to the external capacitor 9 and stored therein.

When a voltage Vdc of the DC power source 165 is output to the AC terminals a and b of the basic unit as a positive terminal voltage, as gate drive signals, an, ON signal is input to the paired signal lines u3 and un3, and an OFF signal is input to the signal line u4. Since the low-voltage-side main semiconductor device 164 is in an OFF state, the potential on the cathode side of the diode 6 increases, and a reverse bias is applied to the diode 6, so that gate drive energy is supplied from the external capacitor 9, and the high-voltage-side main semiconductor device 162 is turned on. Further, as gate drive signals, an OFF signal is input to the paired signal lines u1 and un1, and an ON signal is input to the signal line u2, so that the high-voltage-side main semiconductor device 161 is turned off, and gate drive energy is supplied from the external gate power source 7 to the lower-voltage-side main semiconductor device 163 so that the lower-voltage-side main semiconductor device 163 is turned on. When the voltage of the DC power source 165 is output to the AC terminals a and b of the basic unit as a negative terminal voltage (−Vdc), the above-described circuit similarly operate, but the respective devices operate in reverse. As described above, the voltage Vdc of the DC power source 165 is output to the AC terminals a and b of the basic unit as positive and negative voltages alternately through switching control of the main semiconductor devices, whereby DC voltage and current are converted to AC voltage and current.

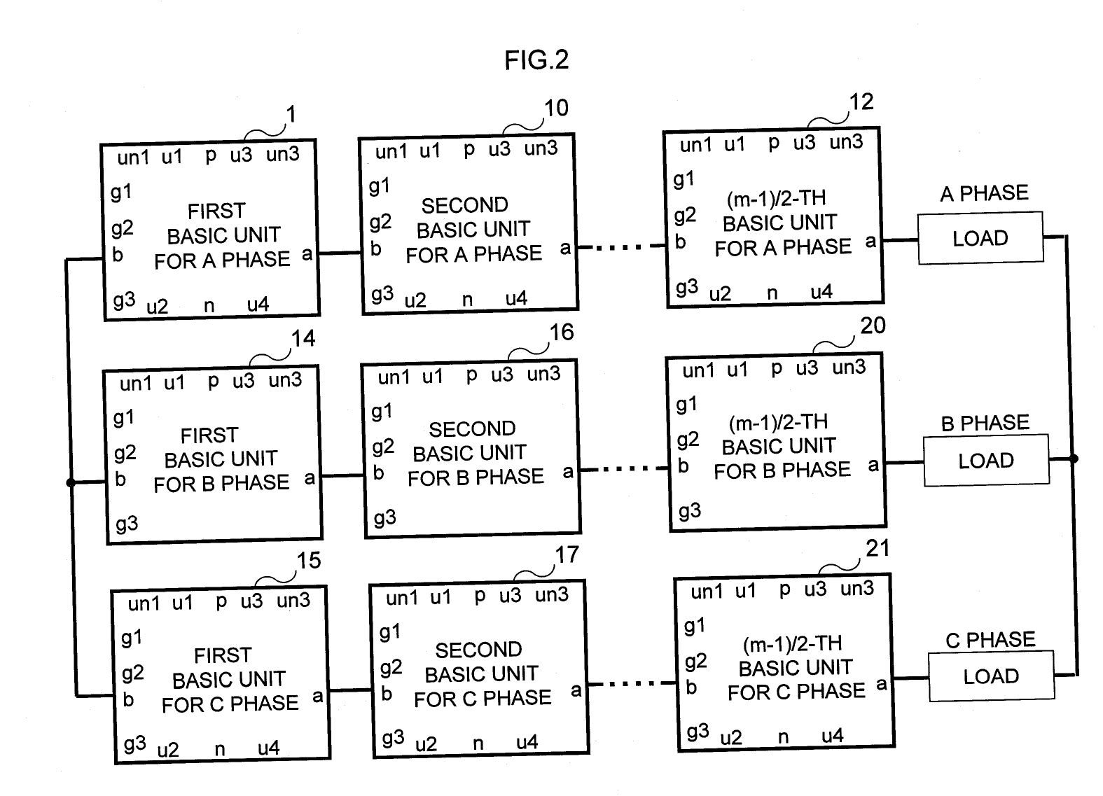

FIG. 2 is an integrated three-phase odd-number-m-level conversion circuit, in which three single-phase odd-number-m-level conversion circuits are connected in parallel. As shown in FIG. 2, the ground lines b of first basic units 1, 14, and 15 for respective phases are connected together; and output lines of (m−1)/2-th basic unit 12, 20, and 21 for respective phases are connected to a load, whereby an integrated three-phase odd-number-m-level conversion circuit is formed.

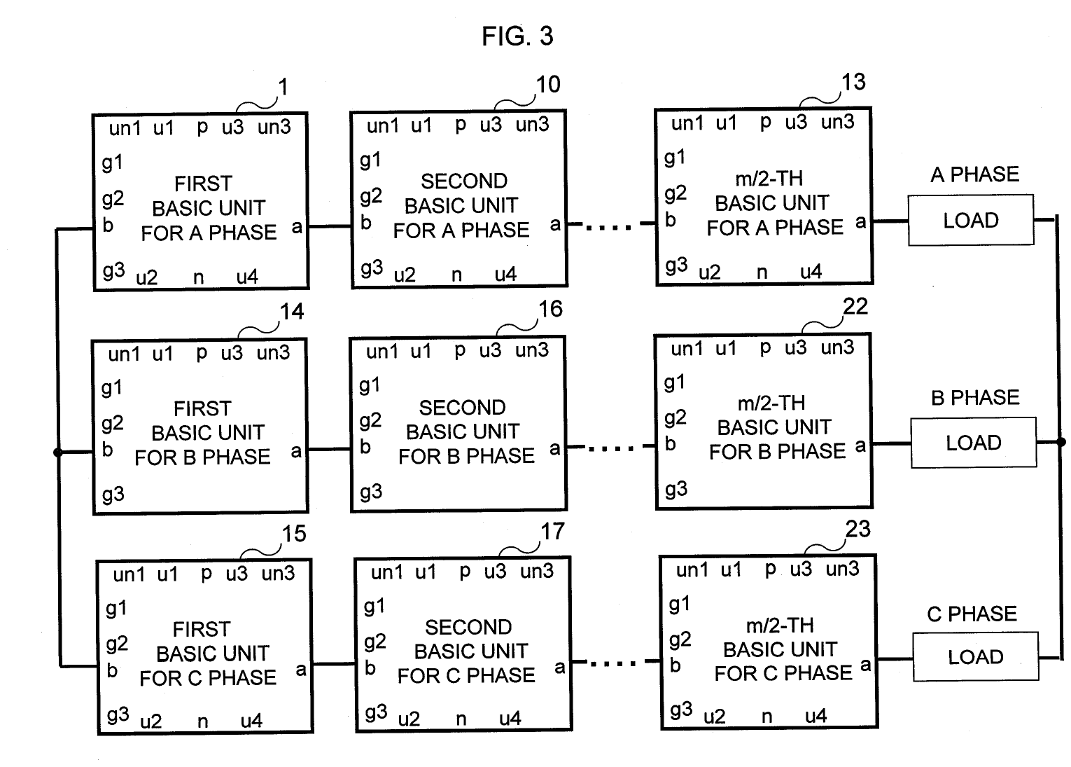

FIG. 3 is an integrated three-phase even-number-m-level conversion circuit, in which three single-phase even-number-m-level conversion circuits are connected in parallel. As shown in FIG. 3, the ground lines b of first basic units 1, 14, and 15 for respective phases are connected together; and output lines of m/2-th basic unit 13, 22, and 23 for respective phases are connected to a load, whereby an integrated three-phase even-number-m-level conversion circuit is formed.

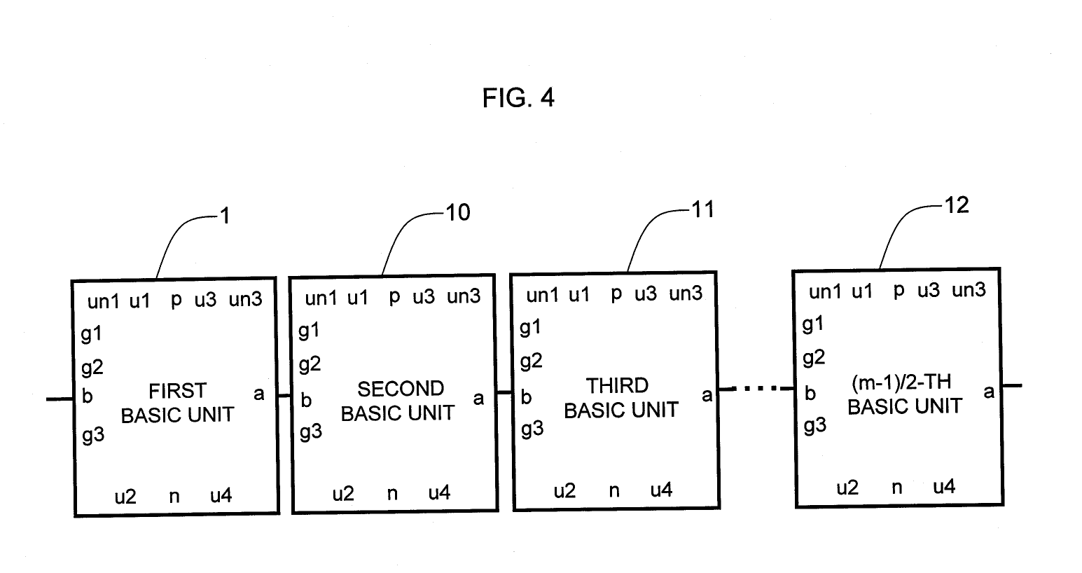

FIG. 4 is an integrated single-phase odd-number-m-level conversion circuit in which (m−1)/2 basic units 1 of FIG. 1 are connected in series. As shown in FIG. 4, the AC terminals of the first basic unit 1 to the (m−1)/2-th basic unit 12 are connected to form an integrated single-phase odd-number-m-level conversion circuit.

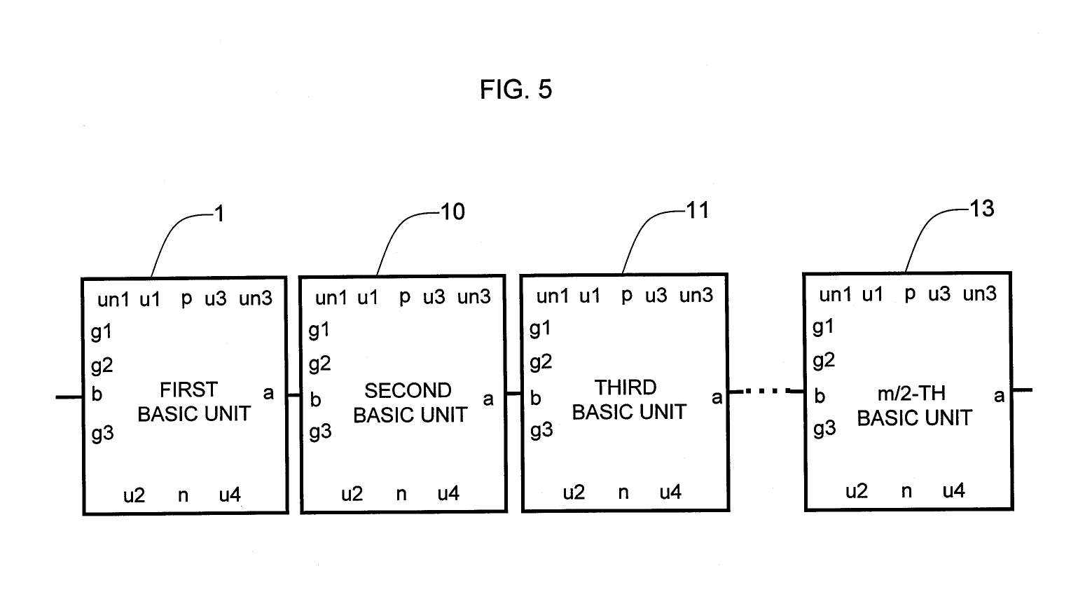

FIG. 5 is an integrated single-phase even-number-m-level conversion circuit in which m/2 basic units 1 of FIG. 1 are connected in series. As shown in FIG. 5, the AC terminals of the first basic unit 1 to the m/2-th basic unit 13 are connected to form an integrated single-phase even-number-m-level conversion circuit.

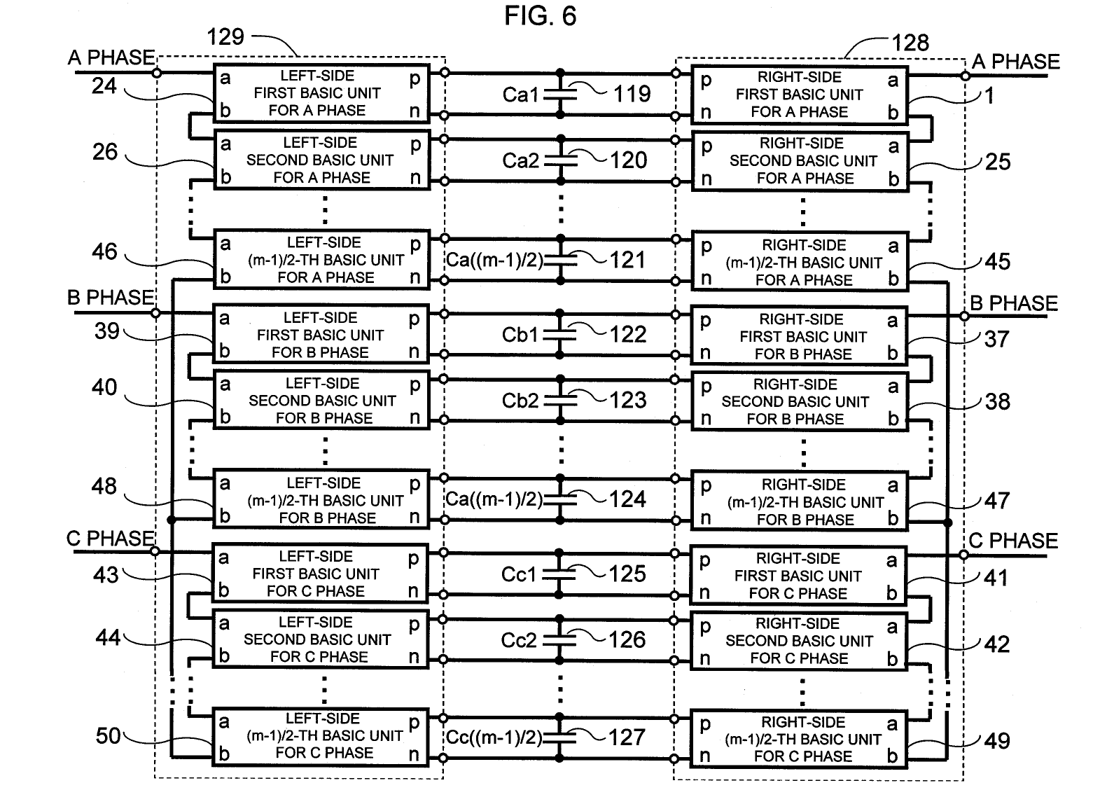

FIG. 6 shows three-phase odd-number-(m−1)/2-level AC-DC-AC conversion circuit in which integrated three-phase odd-number-(m−1)/2-level conversion circuits 128 and 129 as shown in FIG. 2 are symmetrically connected via a DC section which includes first DC-link capacitors 119, 122, 125 for respective phases to (m−1)/2-th DC-link capacitors 121, 124, 127 for respective phases.

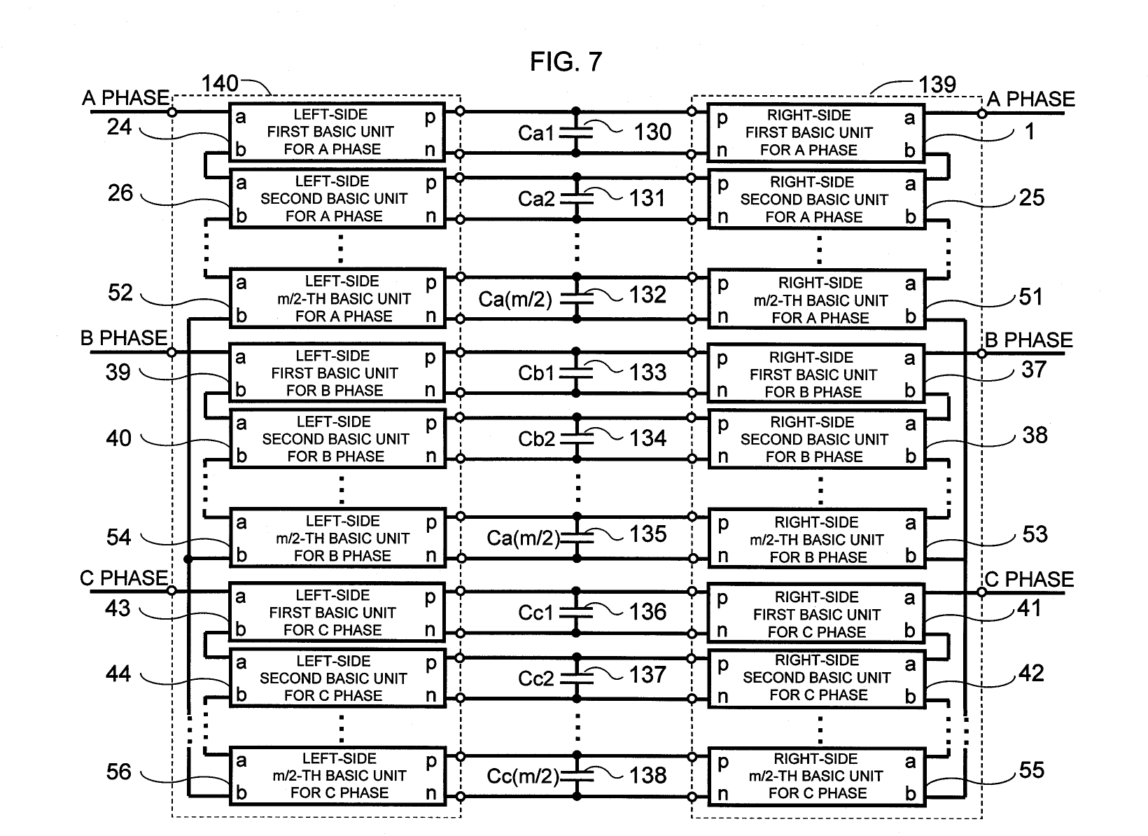

FIG. 7 shows three-phase even-number-m/2-level AC-DC-AC conversion circuit in which integrated three-phase even-number-m/2-level conversion circuits 139 and 140 as shown in FIG. 3 are symmetrically connected via a DC section which includes first DC-link capacitors 130, 133, 136 for respective phases to m/2-th DC-link capacitors 132, 135, 138 for respective phases.

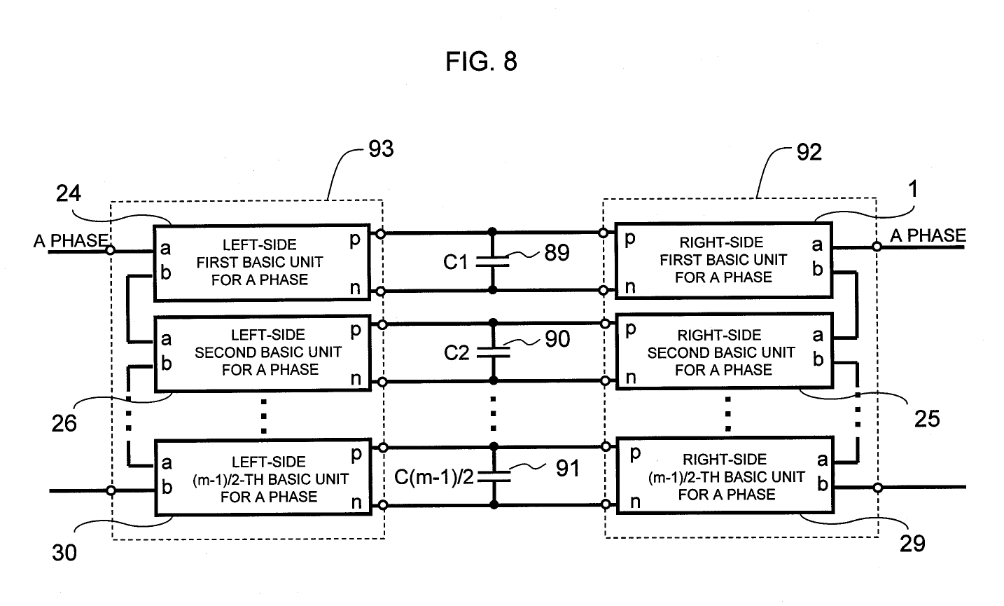

FIG. 8 shows single-phase odd-number-(m−1)/2-level AC-DC-AC conversion circuit in which integrated single-phase odd-number-(m−1)/2-level conversion circuits 92 and 93 as shown in FIG. 4 are symmetrically connected via a DC section which includes a first DC-link capacitor 89 to a (m−1)/2-th DC-link capacitor 91.

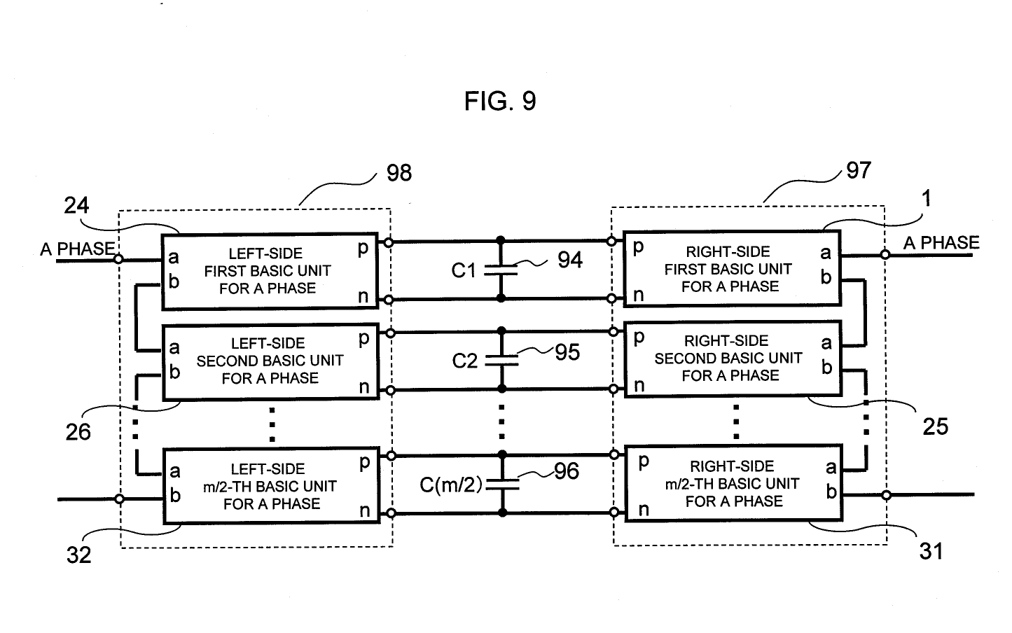

FIG. 9 shows single-phase even-number-m/2-level AC-DC-AC conversion circuit in which integrated single-phase even-number-m/2-level conversion circuits 97 and 98 as shown in FIG. 5 are symmetrically connected via a DC section which includes a first DC-link capacitor 94 to an m/2-th DC-link capacitor 96.

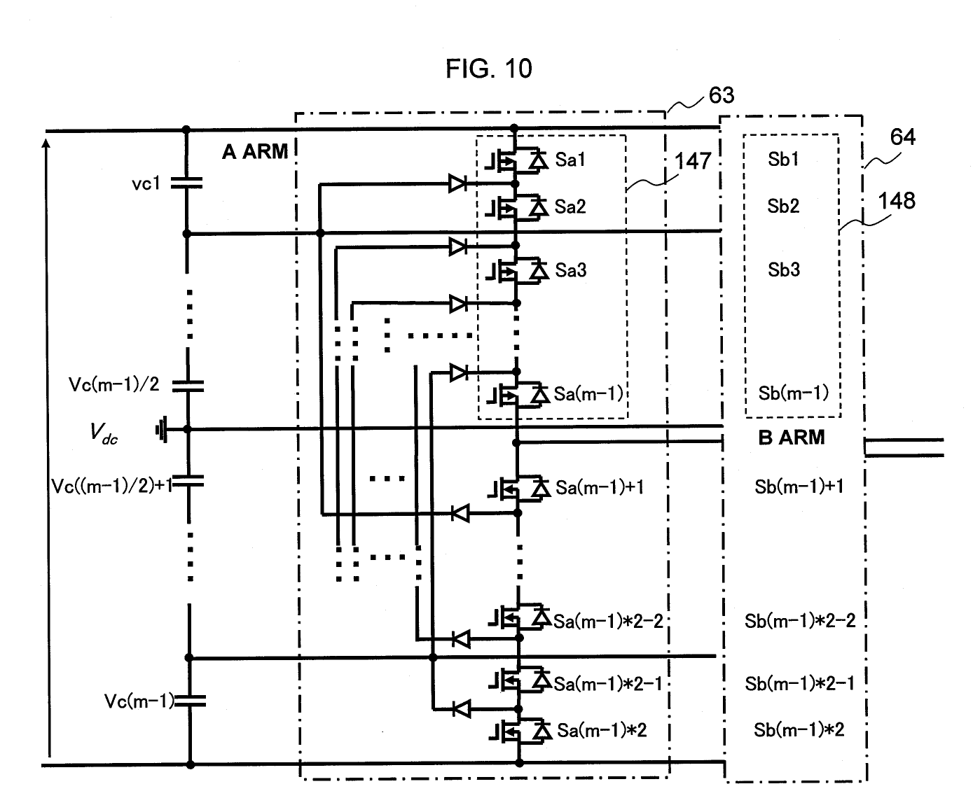

FIG. 10 shows an integrated single-phase m-level conversion circuit characterized in that the first through (m−1)/2-th switching semiconductor devices in the upper subarms 147 and 148 of A and B arms 63 and 64 are formed by p-channel MOSFETs.

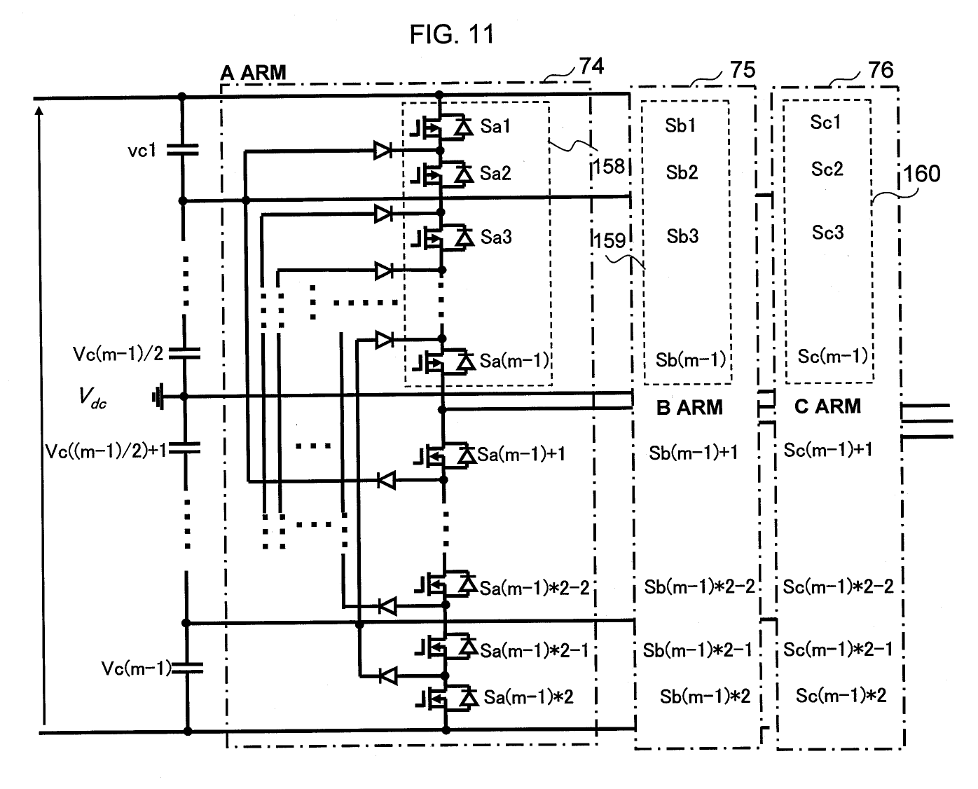

FIG. 11 shows an integrated three-phase m-level conversion circuit characterized in that the first through (m−1)/2-th switching semiconductor devices in the upper subarms 158, 159, and 160 of A, B, and C arms 74, 75, and 76 are formed by p-channel MOSFETs.

### Second Embodiment

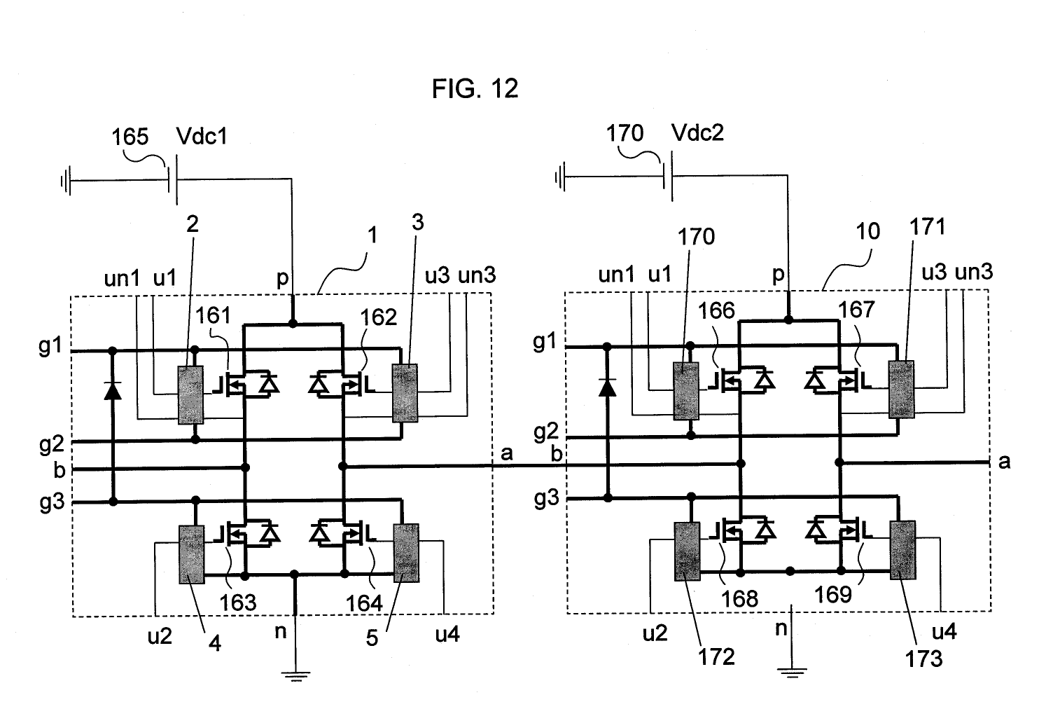

FIG. 12 is an integrated single-phase 4-level/5-level conversion circuit in which two basic units 1 of FIG. 1 are connected in series. As shown in FIG. 12, the output terminal a of the first basic unit 1 is connected to the ground terminal b of the second basic unit 10 so as to form an integrated single-phase 4-level/5-level conversion circuit.

For the integrated single-phase 4-level/5-level conversion circuit shown in FIG. 12, operation for converting DC voltage to a 4-level/5-level AC voltage waveform will be described. For example, when the high-voltage-side main semiconductor device 162 and the low-voltage-side main semiconductor device 163 of the front-stage, single-phase 3-level conversion circuit 1 are on and the high-voltage-side main semiconductor device 161 and the low-voltage-side main semiconductor device 164 thereof are off, the conversion circuit 1 outputs a voltage Vdc1 of a DC power source 165 as a positive voltage. Further, when the high-voltage-side main semiconductor device 167 and the low-voltage-side main semiconductor device 168 of the rear-stage, single-phase 3-level conversion circuit 10 are on and the high-voltage-side main semiconductor device 166 and the low-voltage-side main semiconductor device 169 thereof are off, the conversion circuit 10 outputs a voltage Vdc2 of a DC power source 170 as a positive voltage. Thus, the integrated single-phase 4-level/5-level conversion circuit can output a voltage corresponding to Vdc1+Vdc2. Further, for example, when the conversion circuit 1 outputs the voltage Vdc1 of a DC power source 165 as a positive voltage, and the rear-stage, single-phase 3-level conversion circuit 10 outputs a zero electric potential because the high-voltage-side main semiconductor devices 166 and 167 are on and the low-voltage-side main semiconductor devices 168 and 169 are off, the integrated single-phase 4-level/5-level conversion circuit can output a voltage corresponding to Vdc1. Further, when the upper arm main semiconductor devices of the front-stage and rear-stage single-phase 3-level conversion circuits 1 and 10 are on and the lower arm main semiconductor devices thereof are off, the integrated single-phase 4-level/5-level conversion circuit can output a zero electric potential. For example, when the high-voltage-side main semiconductor device 161 and the low-voltage-side main semiconductor device 164 of the front-stage, single-phase 3-level conversion circuit 1 are on and the high-voltage-side main semiconductor device 162 and the low-voltage-side main semiconductor device 163 thereof are off, the conversion circuit 1 outputs the voltage Vdc1 of the DC power source 165 as a negative voltage (−Vdc1). Further, when the high-voltage-side main semiconductor device 166 and the low-voltage-side main semiconductor device 169 of the rear-stage, single-phase 3-level conversion circuit 10 are on and the high-voltage-side main semiconductor device 167 and the low-voltage-side main semiconductor device 168 thereof are off, the conversion circuit 10 outputs the voltage Vdc2 of the DC power source 170 as a negative voltage (−Vdc2). Thus, the integrated single-phase 4-level/5-level conversion circuit can output a voltage corresponding to −(Vdc1+Vdc2). Further, for example, when the conversion circuit 1 outputs the voltage Vdc1 of a DC power source 165 as a negative voltage (−Vdc1) and the rear-stage, single-phase 3-level conversion circuit 10 outputs a zero electric potential, the integrated single-phase 4-level/5-level conversion circuit can output a voltage corresponding to −Vdc1. As described above, the integrated single-phase 4-level/5-level conversion circuit can output a voltage waveform of 5 levels of Vdc1+Vdc2, Vdc1 or Vdc2, zero electric potential, −Vdc1 or −Vdc2, and −(Vdc1+Vdc2) through proper switching control. Therefore, the integrated single-phase 4-level/5-level conversion circuit can generate a single-phase 4-level or 5-level AC voltage waveform from DC voltage.

### Third Embodiment

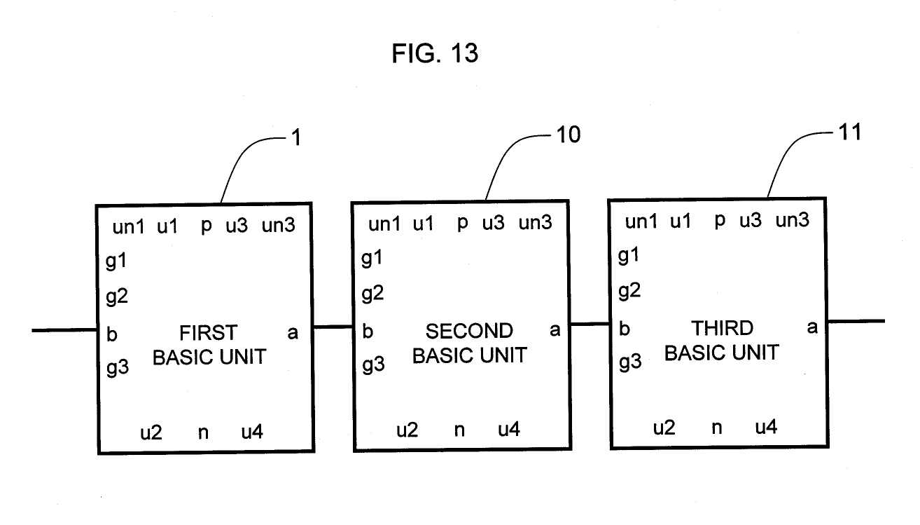

FIG. 13 is an integrated single-phase 6-level/7-level conversion circuit in which three basic units 1 of FIG. 1 are connected in series. As shown in FIG. 13, the output terminal a of the first basic unit 1 is connected to the ground terminal b of the second basic unit 10, and the output terminal a of the second basic unit 10 is connected to the ground terminal b of the third basic unit 11, whereby an integrated single-phase 6-level/7-level conversion circuit is formed. For the integrated single-phase 6-level/7-level conversion circuit shown in FIG. 13, operation for converting DC voltage to a 6-level/7-level AC voltage waveform will be described. As described in Second Embodiment, each of the basic units 1, 10, and 11 can output a 3-level voltage waveform. The integrated single-phase 6-level/7-level conversion circuit can output a 7-level voltage waveform, with the zero electric potential of the basic units 1, 10, and 11 serving as a common electric potential, and thus can generate a single-phase 6-level or 7-level AC voltage waveform from DC voltage.

### Fourth Embodiment

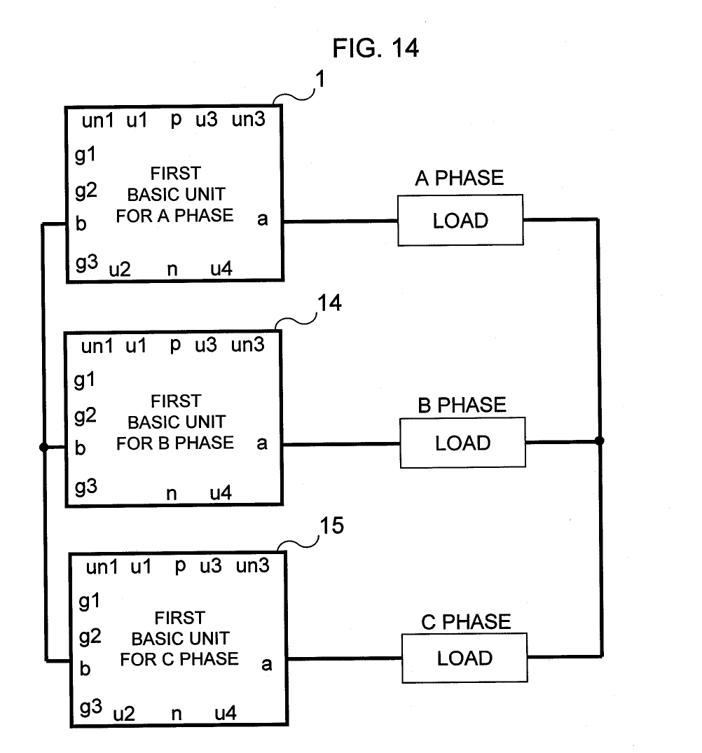

FIG. 14 is an integrated three-phase 3-level conversion circuit in which three basic units 1 of FIG. 1 are connected in parallel. As shown in FIG. 14, the output terminals a of the first basic units 1, 14, and 15 for respective phases are connected to respective loads, and the ground terminals b of the first basic units 1, 14, and 15 are connected together, whereby an integrated three-phase 3-level conversion circuit is formed.

For the integrated three-phase 3-level conversion circuit shown in FIG. 14, operation for converting DC voltage to a 3-level AC voltage waveform will be described. As described in Second Embodiment, each of the basic units 1, 14, and 15 can output a 3-level voltage waveform. Therefore, the integrated three-phase 3-level conversion circuit can convert DC voltage to a three-phase 3-level AC voltage.

### Fifth Embodiment

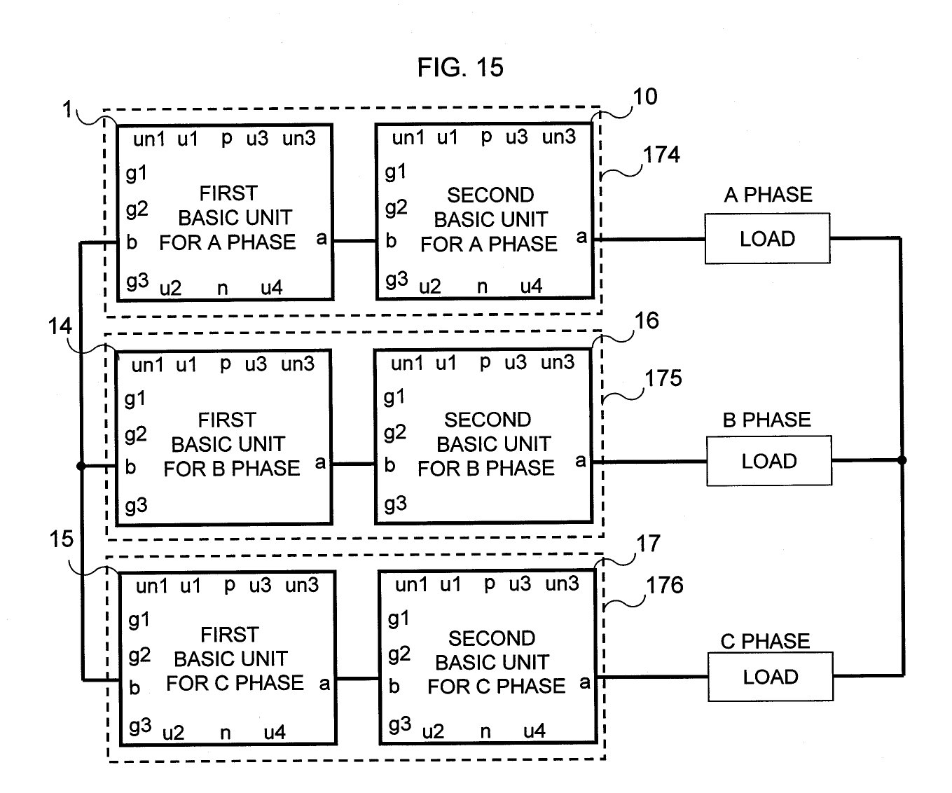

FIG. 15 is an integrated three-phase 4-level/5-level conversion circuit in which three single-phase 4-level/5-level conversion circuits of FIG. 12 are connected in parallel. As shown in FIG. 15, the ground terminals b of the first basic units 1, 14, and 15 for respective phases are connected together, and the output terminals a of the second basic units 10, 16, and 17 for respective phases are connected to respective loads, whereby an integrated three-phase 4-level/5-level conversion circuit is formed.

For the integrated three-phase 4-level/5-level conversion circuit shown in FIG. 15, operation for converting DC voltage to a 4-level/5-level AC voltage waveform will be described. As described in Second Embodiment, each of the single-phase 4-level/5-level conversion circuits 174, 175, and 176 for respective phases can output a 4-level/5-level voltage waveform. Therefore, the integrated three-phase 4-level/5-level conversion circuit can convert DC voltage to a three-phase 4-level/5-level AC voltage.

### Sixth Embodiment

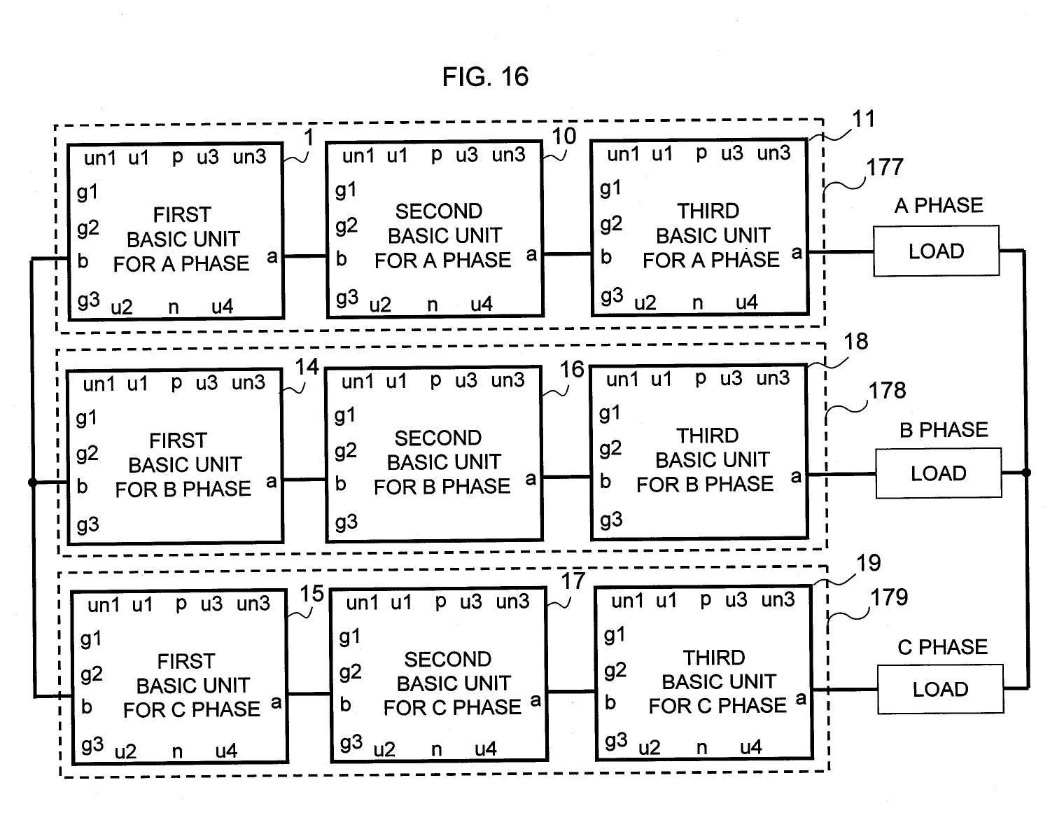

FIG. 16 is an integrated three-phase 6-level/7-level conversion circuit in which three single-phase 6-level/7-level conversion circuits of FIG. 13 are connected in parallel. As shown in FIG. 16, the ground terminals b of the first basic units 1, 14, and 15 for respective phases are connected together, and the output terminals a of the third basic units 11, 18, and 19 for respective phases are connected to respective loads, whereby an integrated three-phase 6-level/7-level conversion circuit is formed.

For the integrated three-phase 6-level/7-level conversion circuit shown in FIG. 16, operation for converting DC voltage to a 6-level/7-level AC voltage waveform will be described. As described in Third Embodiment, each of the single-phase 6-level/7-level conversion circuits 177, 178, and 179 for respective phases can output a 6-level/7-level voltage waveform. Therefore, the integrated three-phase 6-level/7-level conversion circuit can convert DC voltage to a three-phase 6-level/7-level AC voltage.

### Seventh Embodiment

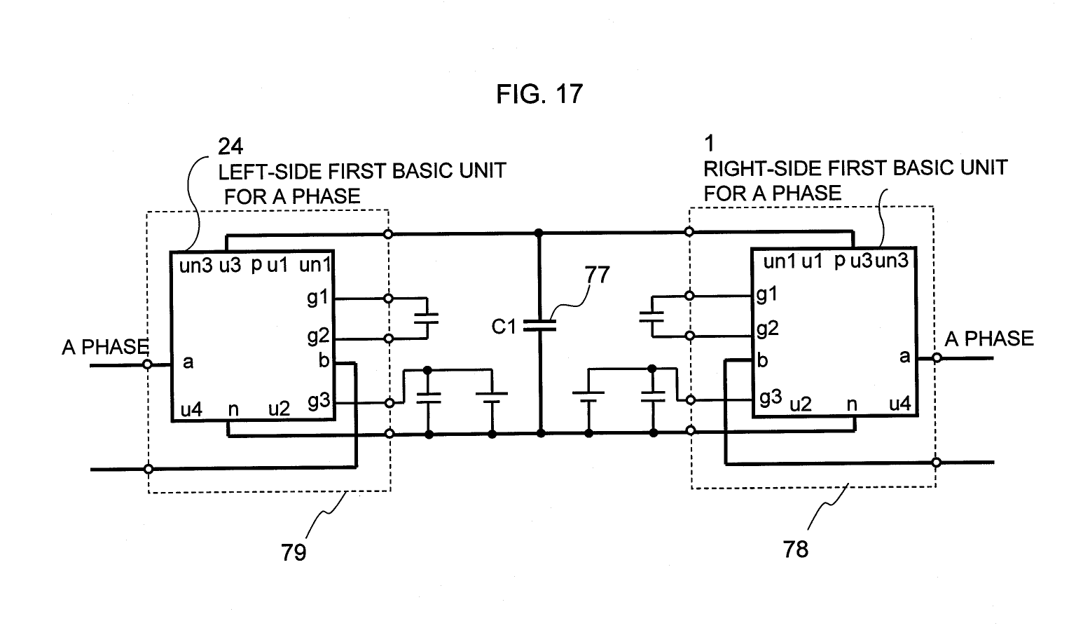

FIG. 17 shows a single-phase 3-level AC-DC-AC conversion circuit in which integrated single-phase 3-level conversion circuits (basic units 1) 78 and 79 as shown in FIG. 1 are symmetrically connected via a DC section which includes a DC-link capacitor 77.

In the integrated single-phase 3-level AC-DC-AC conversion circuit shown in FIG. 17, as described in Second Embodiment, the right-side single-phase 3-level conversion circuit 78 can output a 3-level voltage waveform, and therefore can convert DC voltage to a single-phase 3-level AC voltage. The left-side single-phase 3-level conversion circuit 79 can output a 3-level voltage waveform that is converted to DC voltage. Therefore, the circuit shown in FIG. 17 can operate as a single-phase 3-level AC-DC-AC conversion circuit.

### Eighth Embodiment

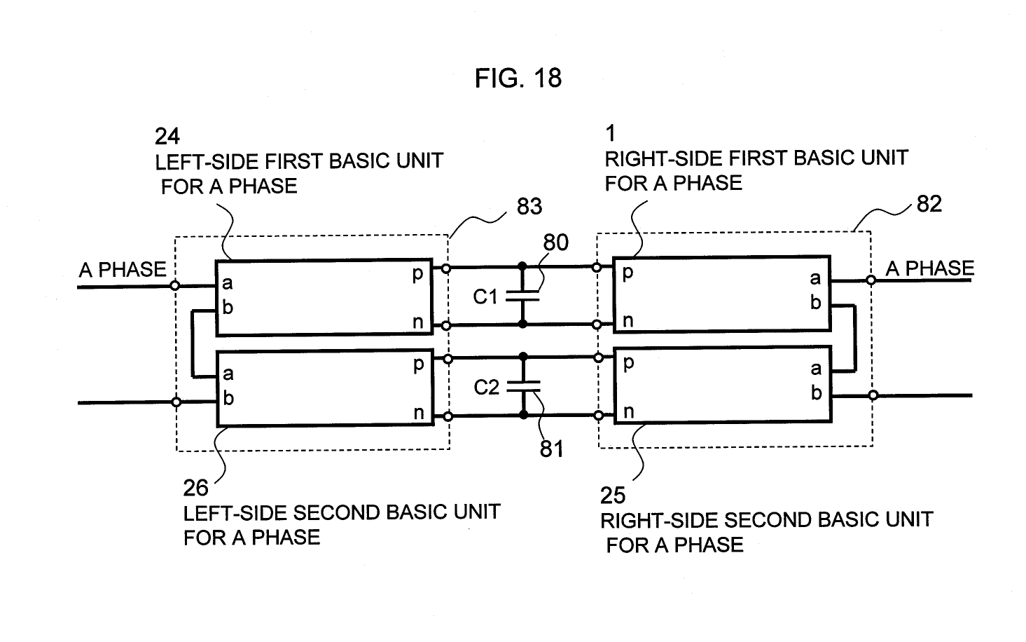

FIG. 18 shows a single-phase 4-level/5-level AC-DC-AC conversion circuit in which integrated single-phase 4-level/5-level conversion circuits 82 and 83 as shown in FIG. 12 are symmetrically connected via a DC section which includes DC-link capacitors 80 and 81.

In the integrated single-phase 4-level/5-level AC-DC-AC conversion circuit shown in FIG. 18, as described in Second Embodiment, the right-side single-phase 4-level/5-level conversion circuit 82 can output a 4-level/5-level voltage waveform, and therefore can convert DC voltage to a single-phase 4-level/5-level AC voltage. The left-side single-phase 4-level/5-level conversion circuit 83 can output a 4-level/5-level voltage waveform that is converted to DC voltage. Therefore, the circuit shown in FIG. 18 can operate as a single-phase 4-level/5-level AC-DC-AC conversion circuit.

### Ninth Embodiment

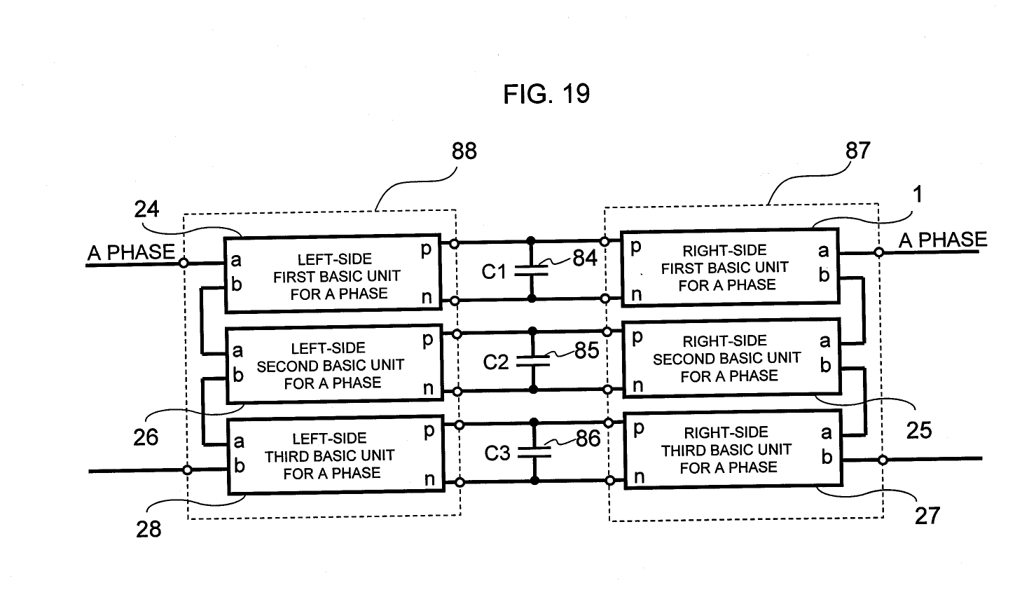

FIG. 19 shows a single-phase 6-level/7-level AC-DC-AC conversion circuit in which integrated single-phase 6-level/7-level conversion circuits 87 and 88 as shown in FIG. 13 are symmetrically connected via a DC section which includes DC-link capacitors 84, 85, and 86.

In the integrated single-phase 6-level/7-level AC-DC-AC conversion circuit shown in FIG. 19, as described in Third Embodiment, the right-side single-phase 6-level/7-level conversion circuit 87 can output a 6-level/7-level voltage waveform, and therefore can convert DC voltage to a single-phase 6-level/7-level AC voltage. The left-side single-phase 6-level/7-level conversion circuit 88 can output a 6-level/7-level voltage waveform that is converted to DC voltage. Therefore, the circuit shown in FIG. 19 can operate as a single-phase 6-level/7-level AC-DC-AC conversion circuit.

### Tenth Embodiment

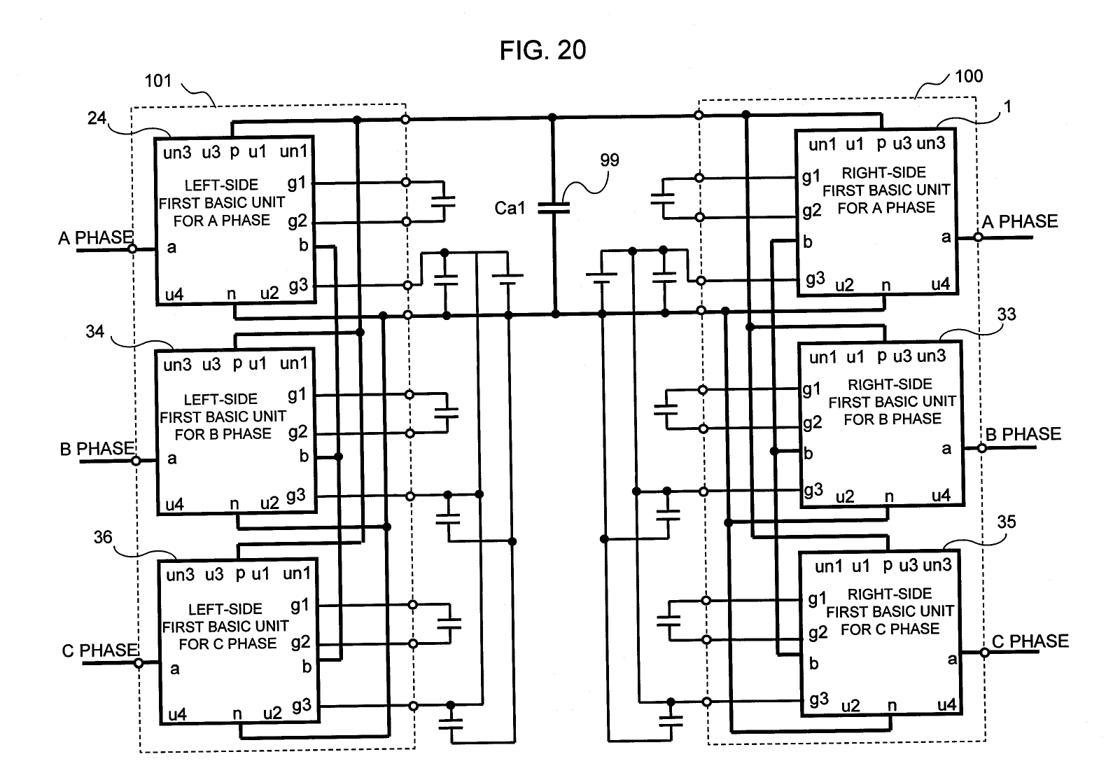

FIG. 20 shows a three-phase 3-level AC-DC-AC conversion circuit in which integrated three-phase 3-level conversion circuits 100 and 101 as shown in FIG. 14 are symmetrically connected via a DC section which includes a DC-link capacitor 99.

In the integrated three-phase 3-level AC-DC-AC conversion circuit shown in FIG. 20, as described in Fourth Embodiment, the right-side three-phase 3-level conversion circuit 100 can output a three-phase 3-level voltage waveform to thereby convert DC voltage to a three-phase 3-level AC voltage. The left-side three-phase 3-level conversion circuit 101 can output a 3-level voltage waveform that is converted to DC voltage. Therefore, the circuit shown in FIG. 20 can operate as a three-phase 3-level AC-DC-AC conversion circuit.

In the circuit of FIG. 20, the integrated three-phase 3-level conversion circuits 100 and 101 share common positive and negative DC terminals. Therefore, as shown in FIG. 20, the integrated three-phase 3-level conversion circuits 100 and 101 each have a common wiring structure such that the positive and negative terminals are formed as common wiring lines.

### Eleventh Embodiment

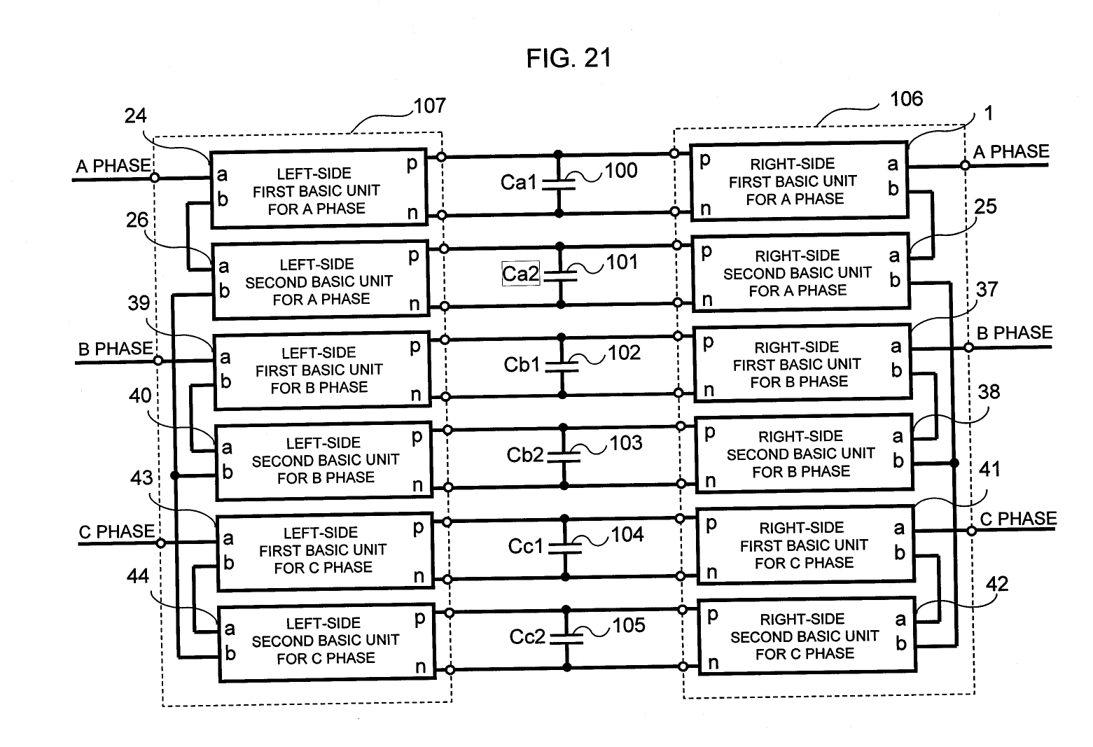

FIG. 21 shows a three-phase 4-level/5-level AC-DC-AC conversion circuit in which integrated three-phase 4-level/5-level conversion circuits 106 and 107 as shown in FIG. 15 are symmetrically connected via a DC section which includes DC-link capacitor 100, 101, 102, 103, 104, and 105.

In the integrated three-phase 4-level/5-level AC-DC-AC conversion circuit shown in FIG. 21, as described in Fifth Embodiment, the right-side three-phase 4-level/5-level conversion circuit 106 can output a three-phase 4-level/5-level voltage waveform to thereby convert DC voltage to a three-phase 4-level/5-level AC voltage. The left-side three-phase 4-level/5-level conversion circuit 107 can output a 4-level/5-level voltage waveform that is converted to DC voltage. Therefore, the circuit shown in FIG. 21 can operate as a three-phase 4-level/5-level AC-DC-AC conversion circuit.

### Twelfth Embodiment

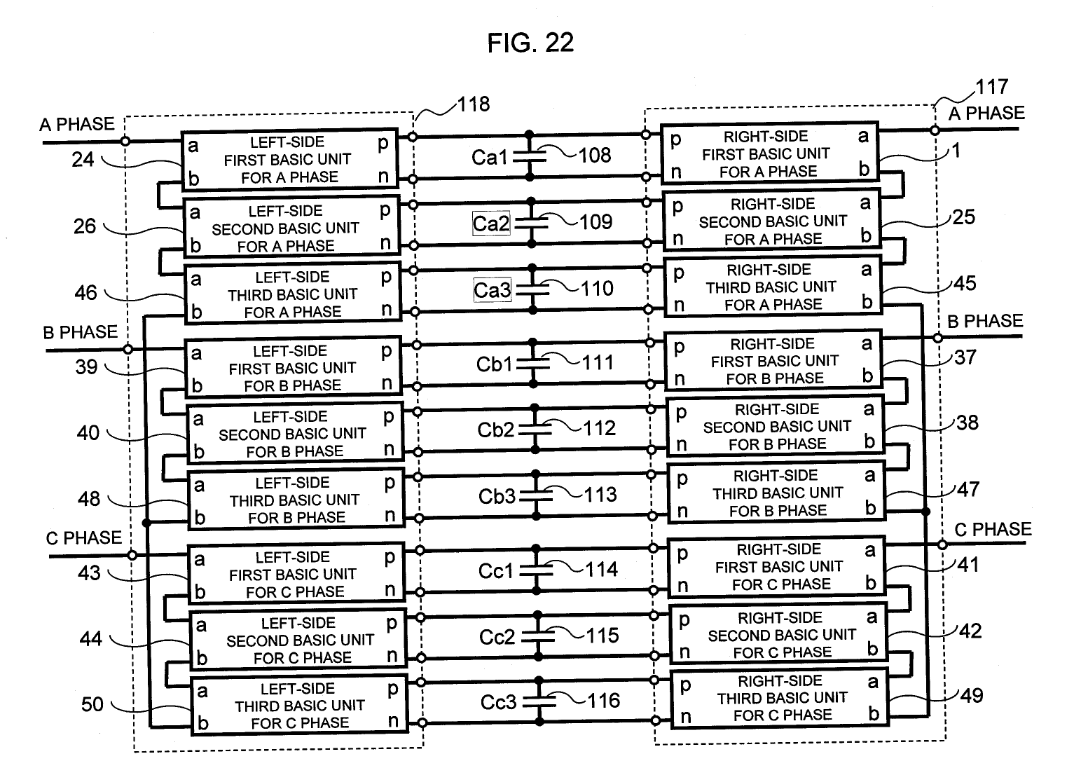

FIG. 22 shows a three-phase 6-level/7-level AC-DC-AC conversion circuit in which integrated three-phase 6-level/7-level conversion circuits 117 and 118 as shown in FIG. 16 are symmetrically connected via a DC section which includes DC-link capacitor 108, 109, 110, 111, 112, 113, 114, 115, and 116.

In the integrated three-phase 6-level/7-level AC-DC-AC conversion circuit shown in FIG. 22, as described in Sixth Embodiment, the right-side three-phase 6-level/7-level conversion circuit 117 can output a three-phase 6-level/7-level voltage waveform to thereby convert DC voltage to a three-phase 6-level/7-level AC voltage. The left-side three-phase 6-level/7-level conversion circuit 118 can output a 6-level/7-level voltage waveform that is converted to DC voltage. Therefore, the circuit shown in FIG. 22 can operate as a three-phase 6-level/7-level AC-DC-AC conversion circuit.

### Thirteenth Embodiment

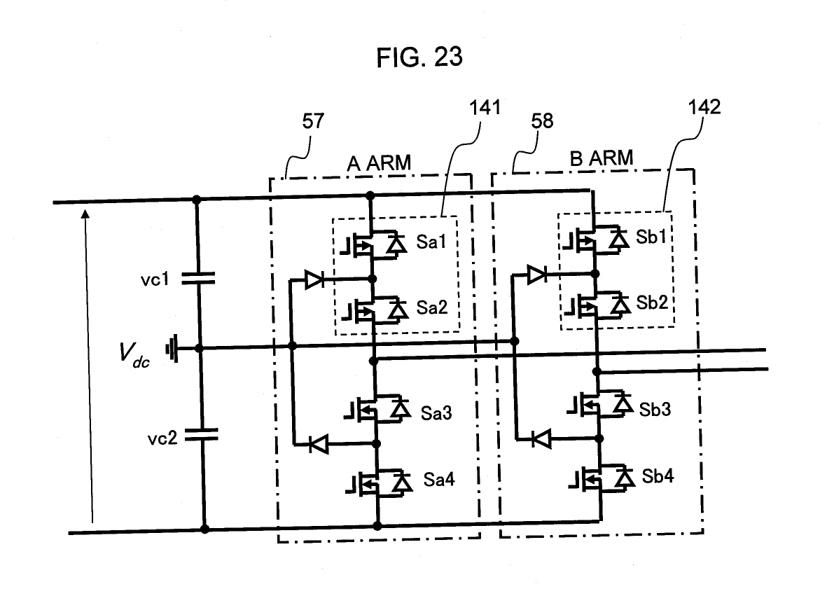

FIG. 23 is an integrated single-phase 3-level conversion circuit characterized in that the first and second switching semiconductor devices in the upper subarms 141 and 142 of A and B arms 57 and 58 are formed by p-channel MOSFETs.

Operation of the integrated single-phase 3-level conversion circuit shown in FIG. 23 and including combined p-channel and n-channel MOSFETs will be described below. A gate drive circuit for an upper-arm main semiconductor device Sa1 of the A arm 57 is commonly used as a gate drive circuit for a lower-arm main semiconductor device Sa3 of the A arm 57, and a gate drive circuit for an upper-arm main semiconductor device Sa2 of the A arm 57 is commonly used as a gate drive circuit for a lower-arm main semiconductor device Sa4 of the A arm 57. When the upper-arm main semiconductor devices Sa1 and Sa2 are in their on states, the lower-arm main semiconductor devices Sa3 and Sa4 are always maintained in their off states (that is, the upper and lower subarms are opposite in terms of on and off states). When the upper-arm main semiconductor devices Sa1 and Sa2 are on (the lower-arm main semiconductor devices Sa3 and Sa4 are off), a DC voltage Vc1 is output to the AC side as a positive voltage. When the upper-arm main semiconductor device Sa2 is on and the upper-arm main semiconductor device Sa1 is off (the lower-arm main semiconductor device Sa3 is on and the lower-arm main semiconductor device Sa4 is off), a zero potential is output to the AC side. When the upper-arm main semiconductor devices Sa1 and Sa2 are off (the lower-arm main semiconductor devices Sa3 and Sa4 are on), a DC voltage Vc2 is output to the AC side as a negative voltage (−Vc2). The B arm 58 operates in the same manner. As described above, DC voltage can be converted to a single-phase 3-level AC voltage through switching of the main semiconductor devices.

### Fourteenth Embodiment

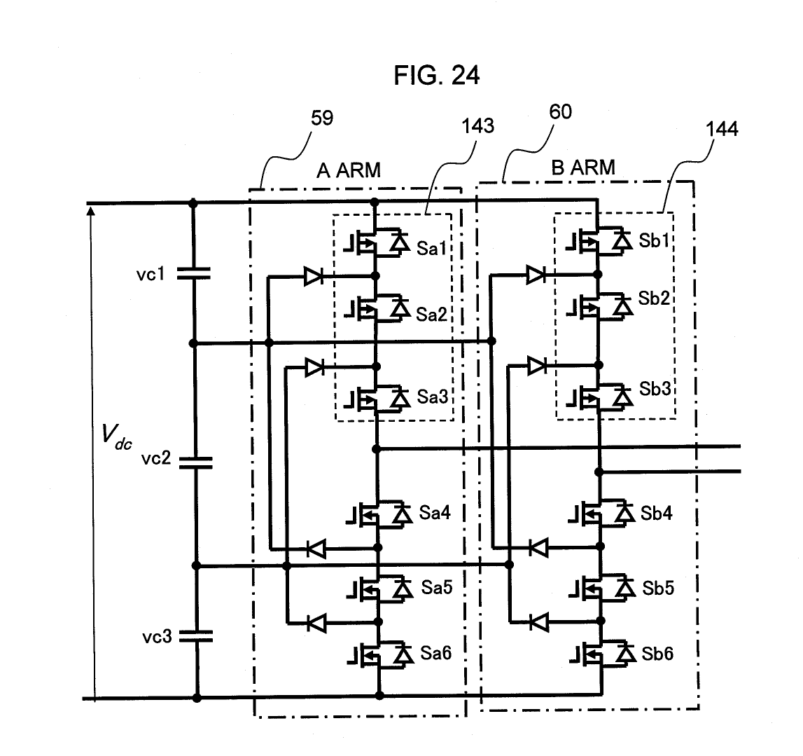

FIG. 24 is an integrated single-phase 4-level conversion circuit characterized in that the first through third switching semiconductor devices in the upper subarms 143 and 144 of A and B arms 59 and 60 are formed by p-channel MOSFETs.

Operation of the integrated single-phase 4-level conversion circuit shown in FIG. 24 and including combined p-channel and n-channel MOSFETs will be described below. A gate drive circuit for an upper-arm main semiconductor device Sa1 of the A arm 59 is commonly used as a gate drive circuit for a lower-arm main semiconductor device Sa4 of the A arm 59, a gate drive circuit for an upper-arm main semiconductor device Sa2 of the A arm 59 is commonly used as a gate drive circuit for a lower-arm main semiconductor device Sa5 of the A arm 59, and a gate drive circuit for an upper-arm main semiconductor device Sa3 of the A arm 59 is commonly used as a gate drive circuit for a lower-arm main semiconductor device Sa6 of the A arm 59. When the upper-arm main semiconductor devices Sa1, Sa2, and Sa3 are in their on states, the lower-arm main semiconductor devices Sa4, Sa5, and Sa6 are always maintained in their off states. When the upper-arm main semiconductor devices Sa1, Sa2, and Sa3 are on (the lower-arm main semiconductor devices Sa4, Sa5, and Sa6 are off), a DC voltage Vdc is output to the AC side as a positive voltage. When the upper-arm main semiconductor devices Sa2 and Sa3 are on and the upper-arm main semiconductor device Sa1 is off (the lower-arm main semiconductor device Sa4 is on and the lower-arm main semiconductor devices Sa5 and Sa6 are off), a voltage corresponding to Vc2+Vc3 is output to the AC side as a positive voltage. When the upper-arm main semiconductor devices Sa1 and Sa2 are off and the upper-arm main semiconductor device Sa3 is on (the lower-arm main semiconductor devices Sa4 and Sa5 are on and the lower-arm main semiconductor device Sa6 is off), a voltage corresponding to Vc2+Vc3 is output to the AC side as a negative voltage (−(Vc2+Vc3)). When the upper-arm main semiconductor devices Sa1, Sa2, and Sa3 are off (the lower-arm main semiconductor devices Sa4, Sa5, and Sa6 are on), a DC voltage Vdc is output to the AC side as a negative voltage (−Vdc). The B arm 60 operates in the same manner. As described above, DC voltage can be converted to a single-phase 4-level AC voltage through switching of the main semiconductor devices.

### Fifteenth Embodiment

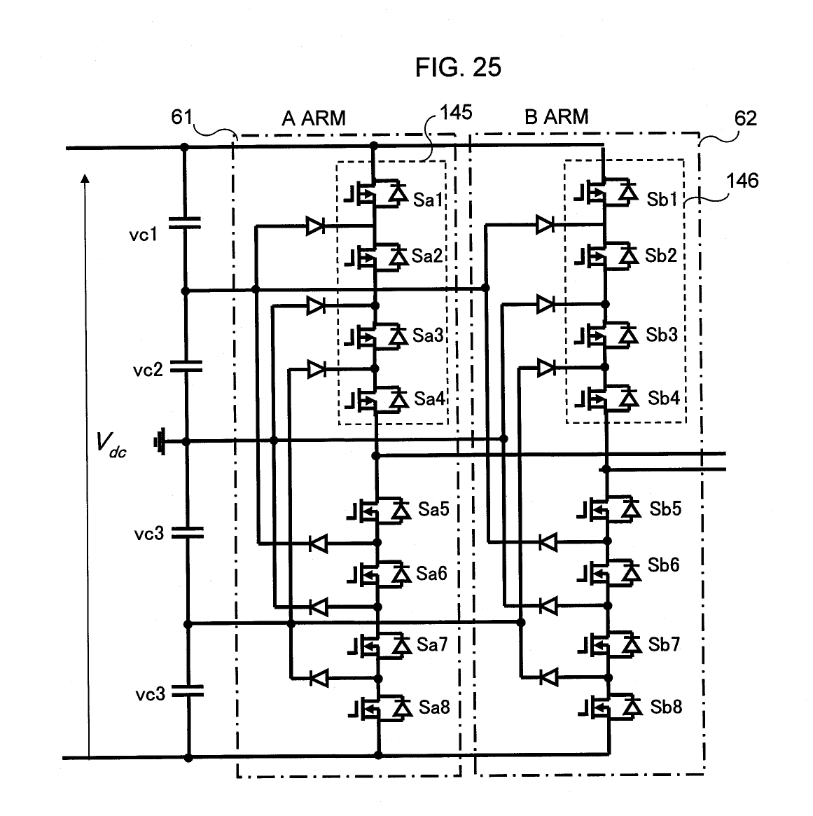

FIG. 25 is an integrated single-phase 5-level conversion circuit characterized in that the first through fourth switching semiconductor devices in the upper subarms 145 and 146 of A and B arms 61 and 62 are formed by p-channel MOSFETs.

Operation of the integrated single-phase 5-level conversion circuit shown in FIG. 25 and including combined p-channel and n-channel MOSFETs will be described below. A gate drive circuit for an upper-arm main semiconductor device Sa1 of the A arm 61 is commonly used as a gate drive circuit for a lower-arm main semiconductor device Sa5 of the A arm 61; a gate drive circuit for an upper-arm main semiconductor device Sa2 of the A arm 61 is commonly used as a gate drive circuit for a lower-arm main semiconductor device Sa6 of the A arm 61; a gate drive circuit for an upper-arm main semiconductor device Sa3 of the A arm 61 is commonly used as a gate drive circuit for a lower-arm main semiconductor device Sa7 of the A arm 61; and a gate drive circuit for an upper-arm main semiconductor device Sa4 of the A arm 61 is commonly used as a gate drive circuit for a lower-arm main semiconductor device Sa8 of the A arm 61. When the upper-arm main semiconductor devices Sa1, Sa2, Sa3, and Sa4 are in their on states, the lower-arm main semiconductor devices Sa5, Sa6, Sa7, and Sa8 are always maintained in their off states. Since the circuit of FIG. 25 can output a voltage waveform of 5 levels; i.e., Vc1+Vc2, Vc2, zero potential, −Vc2, −(Vc1+Vc2), through proper switching control of the main semiconductor devices in the A arm 61 and the B arm 62, the circuit of FIG. 25 can convert DC voltage to a single-phase 5-level AC voltage.

### Sixteenth Embodiment

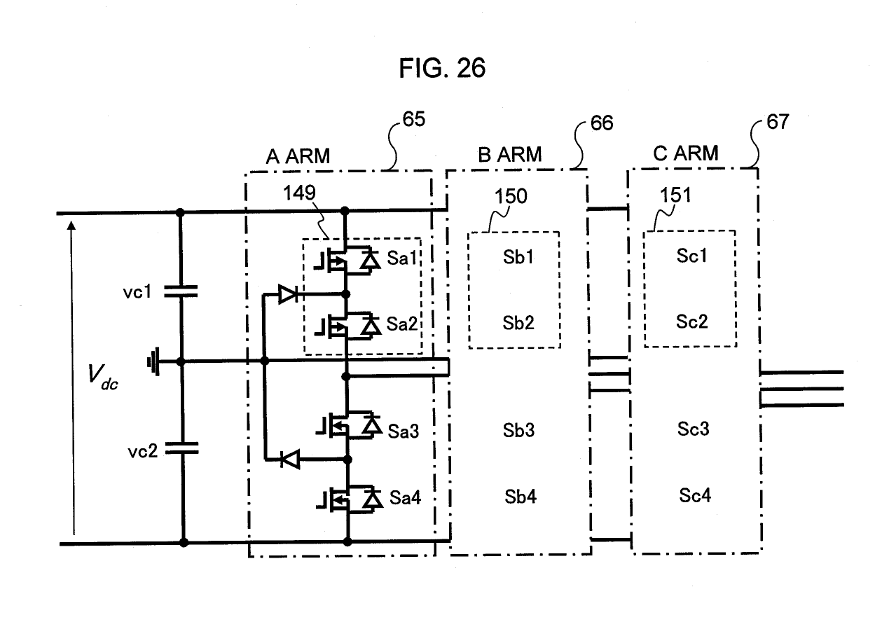

FIG. 26 is an integrated three-phase 3-level conversion circuit characterized in that the first and second switching semiconductor devices in the upper subarms 149, 150, and 151 of A, B, and C arms 65, 66, and 67 are formed by p-channel MOSFETs.

In the integrated three-phase 3-level conversion circuit shown in FIG. 26 and including combined p-channel and n-channel MOSFETs, as described in Thirteenth Embodiment, voltages of three levels; i.e., Vc1, zero potential, and −Vc1 can be output for each phase through parallel connection of three integrated single-phase 3-level conversion circuits. Therefore, the circuit of FIG. 26 can convert DC voltage to a three-phase 3-level AC voltage.

### Seventeenth Embodiment

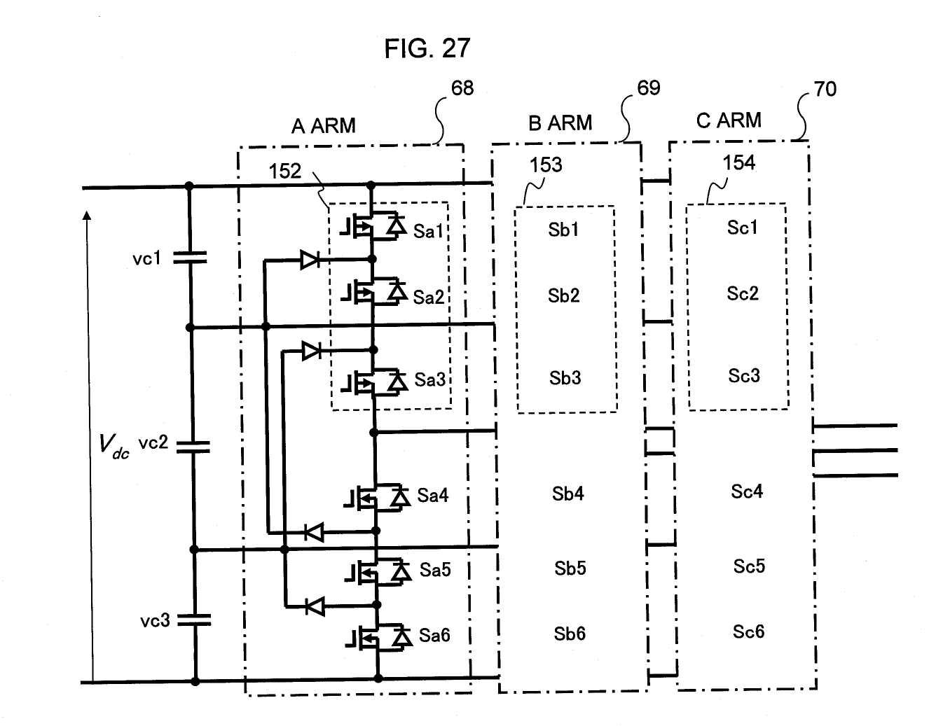

FIG. 27 is an integrated three-phase 4-level conversion circuit characterized in that the first through third switching semiconductor devices in the upper subarms 152, 153, and 154 of A, B, and C arms 68, 69, and 70 are formed by p-channel MOSFETs.

In the integrated three-phase 4-level conversion circuit shown in FIG. 27 and including combined p-channel and n-channel MOSFETs, as described in Fourteen Embodiment, voltages of four levels; i.e., Vdc, Vc2+Vc3, −(Vc2+Vc3), and −Vdc can be output for each phase through parallel connection of three integrated single-phase 4-level conversion circuits. Therefore, the circuit of FIG. 27 can convert DC voltage to a three-phase 4-level AC voltage.

### Eighteenth Embodiment

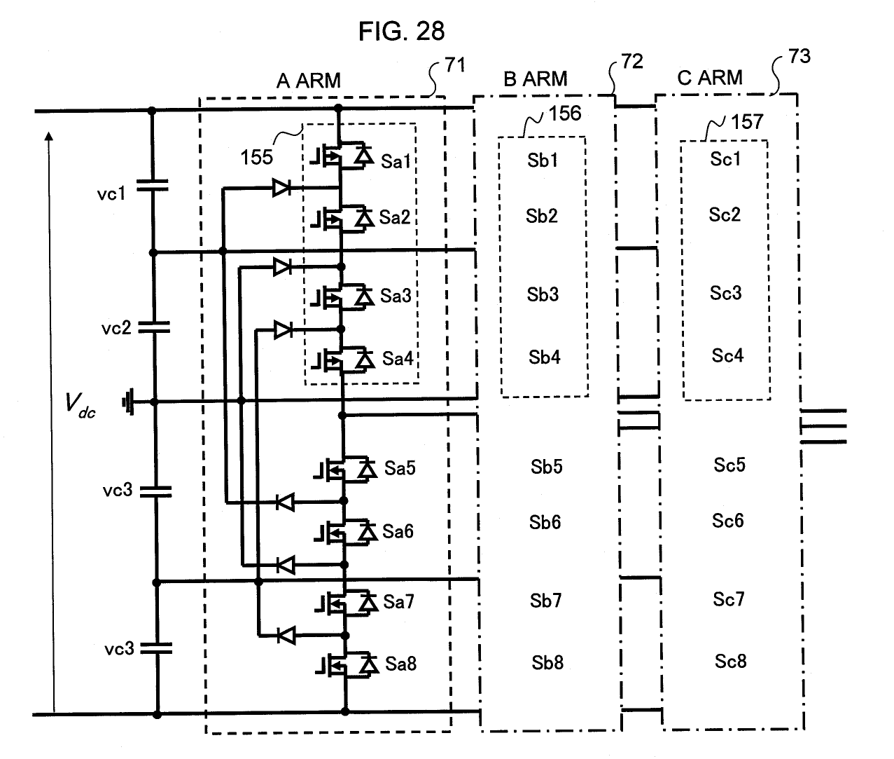

FIG. 28 is an integrated three-phase 5-level conversion circuit characterized in that the first through fourth switching semiconductor devices in the upper subarms 155, 156, and 157 of A, B, and C arms 71, 72, and 73 are formed by p-channel MOSFETs.

In the integrated three-phase 5-level conversion circuit shown in FIG. 28 and including combined p-channel and n-channel MOSFETs, as described in Fifteenth Embodiment, voltages of five levels; i.e., Vc1+Vc2, Vc2, zero potential, −Vc2, and −(Vc1+Vc2) can be output for each phase through parallel connection of three integrated single-phase 5-level conversion circuits. Therefore, the circuit of FIG. 28 can convert DC voltage to a three-phase 5-level AC voltage.

### Nineteenth Embodiment

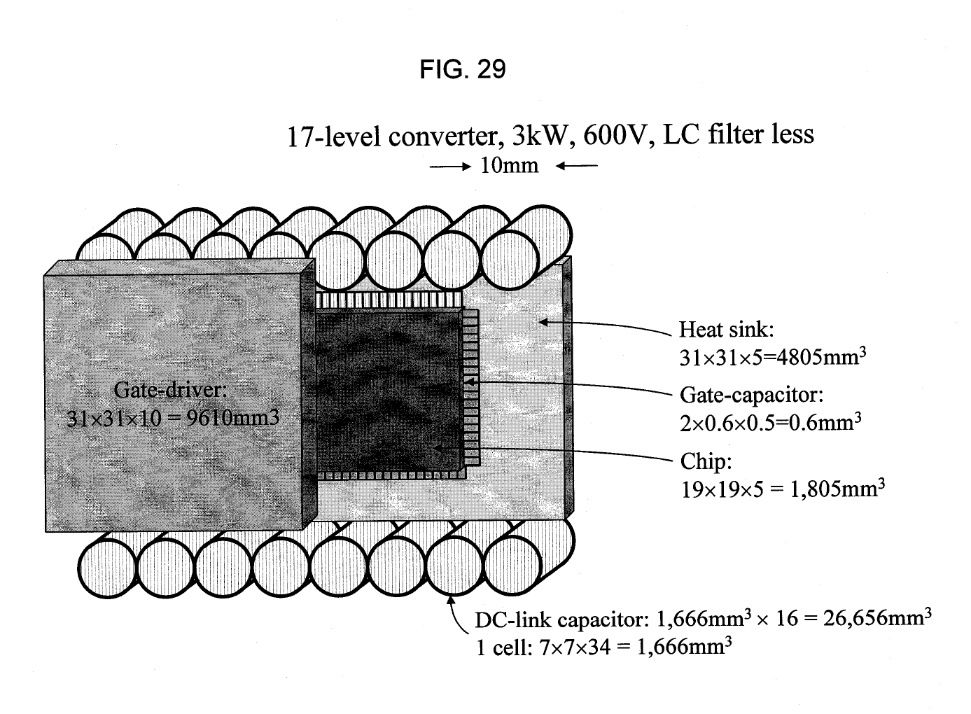

FIG. 29 is an external view showing calculation of the volume of an integrated three-phase 17-level power conversion circuit. The 17-level conversion circuit includes an integrated 17-level main circuit, gate drive circuits, DC-link capacitors, and a cooling unit. Since the total distortion factor of the output voltage waveform of the 17-level conversion circuit is 5% or less, a power converter can be implemented without use of an LC filter.

### Twentieth Embodiment

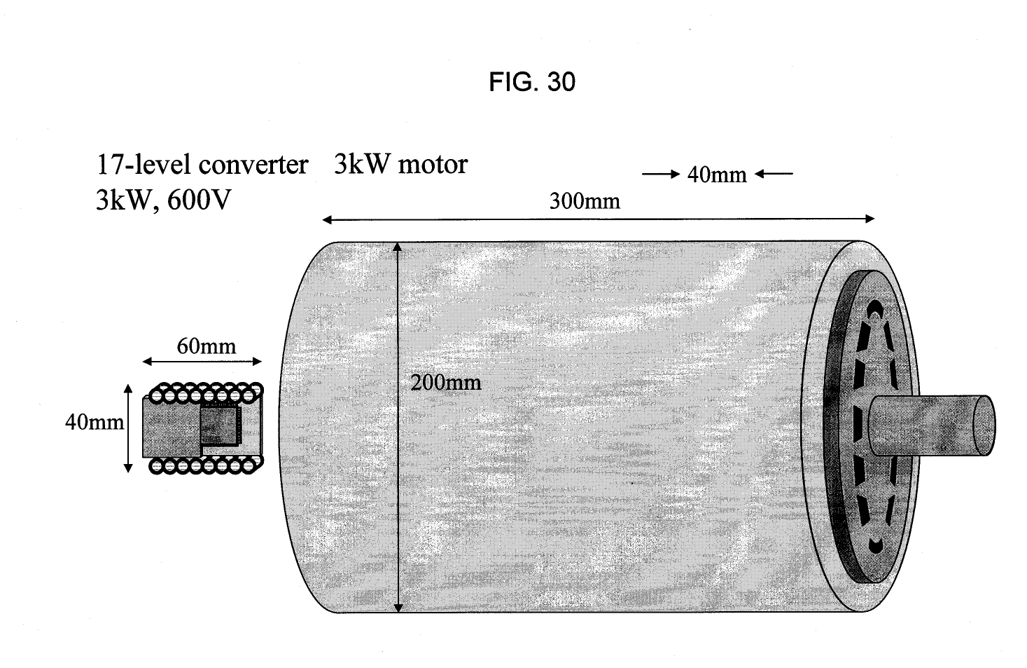

FIG. 30 is an external view for comparing the volume of a 3 kW motor currently sold and the volume of the integrated three-phase 17-level power converter.

### Twenty-First Embodiment

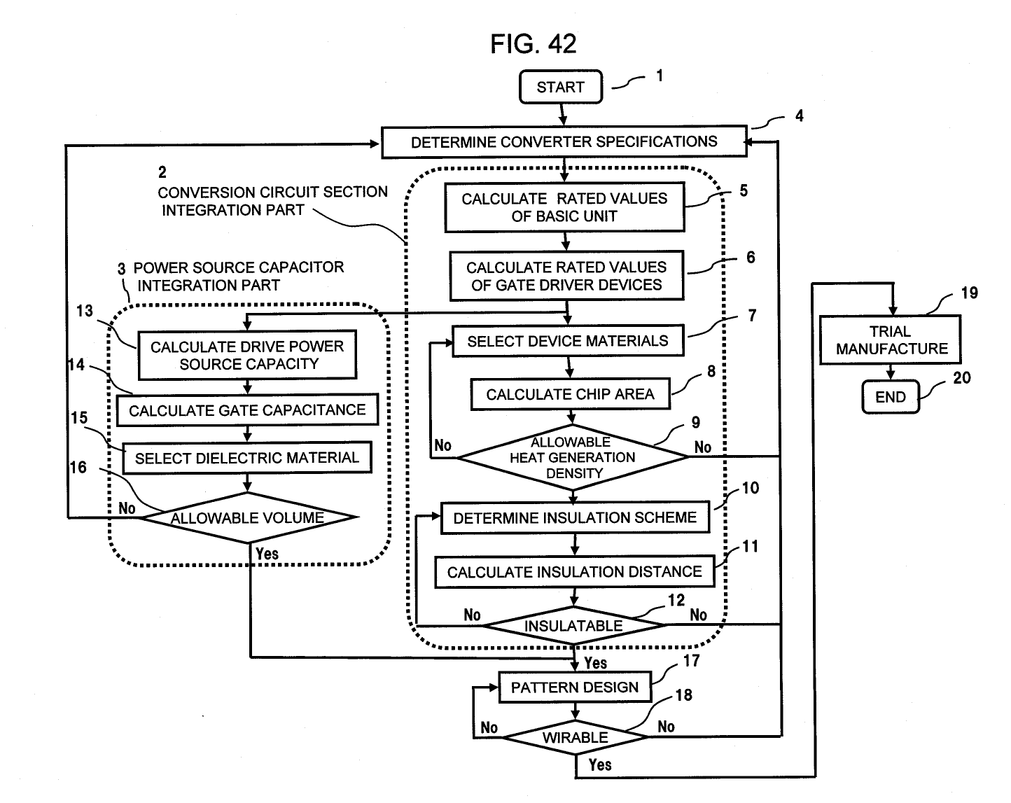

An embodiment for realizing the integrated three-phase 17-level power converter shown in FIG. 29 will be described further. FIG. 42 is a flowchart showing a process of fabricating proposed power integrated circuits such as integrated multi-level circuits.

The flowchart shown in FIG. 42 is mainly composed of Step 2 for integration of a conversion circuit and Step 3 for integration of passive components for power sources. First, in Step 4, an engineer determines specifications of a converter; i.e., voltage, current, the number of levels, and frequency.

In Step 5, the engineer calculates a converter withstanding voltage and rated current required for the basic unit shown in FIG. 1. In Step 6, the engineer similarly calculates a gate voltage for driving semiconductor devices disposed in the basic unit and the withstanding voltage and rated current of gate drivers.

In Step 7, the engineer selects materials for integrating the conversion circuit section, and calculates the chip size of the basic unit from the characteristics of the materials selected in Step 7 and the rated current obtained in Step 5. In Step (determination step) 9, the engineer calculates a heat generation density. When the calculated heat generation density is not greater than an allowable heat generation density, the engineer proceeds to Step 10. When the calculated heat generation density is greater than the allowable heat generation density, the engineer returns to Step 7. When the heat generation density does not become equal to or less than the allowable heat generation density after selection of all the materials, the engineer returns to Step 4.

In Step 10, the engineer selects an insulation scheme for integration; i.e., selects a PN junction separation or a dielectric separation. In Step 11, the engineer calculates a required insulating distance. When the engineer determines in Step (determination step) 12 that the required withstand voltage is attained, the engineer proceeds to Step 17. When the required withstand voltage is not attained, the engineer returns to Step 10. In the case where neither the PN junction separation nor the dielectric separation provides the required withstand voltage, the engineer returns to Step 4.

After Step 6, in Steps 13 to 16, the engineer integrates the capacities of passive components for a drive power source, and integrates capacitors, which are passive components. In Step 13, the engineer calculates a capacity of the drive power source by use of the frequency determined in Step 4, the device withstanding voltage calculated in Step 5 and the device input capacitance. In Step 14, the engineer obtains a capacitance required for the power source, from the gate voltage obtained in Step 6 and the capacity of the drive power source obtained in Step 13. In Step 15, the engineer selects a dielectric material, and determines in Step 16 whether or not the volume is permissible and whether or not integration is possible. When the engineer determines in Step (determination step) 16 that integration is possible, the engineer proceeds to Step 17. When integration is impossible, the engineer returns to Step 4.

In Step 17, the engineer performs pattern design. When the engineer determines in Step (determination step) 18 that wiring is possible, the engineer proceeds to Step 19 for trial manufacture. When wiring is impossible, the engineer returns to Step 17. When a wirable layout cannot be formed even when the pattern design is repeated, the engineer returns to Step 4. The engineer ends the above-descried procedure at Step 20.

### Twenty-Second Embodiment

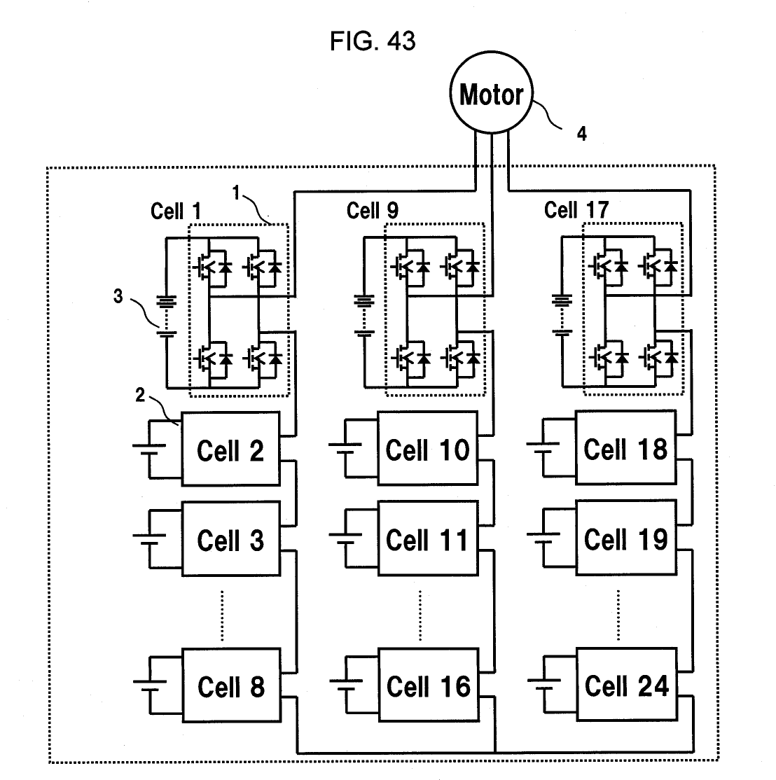

An assumed application and trial manufacture of the proposed power integrated circuit will be described with reference to the flowchart shown in FIG. 42. FIG. 43 is a circuit diagram of the power integrated circuit which is used as a motor drive converter. A block 1 of FIG. 43 represents the basic unit of FIG. 1. A block 2 of FIG. 43 has the same configuration as that of the block 1 of FIG. 43. Reference numeral 3 in FIG. 43 denotes a DC power source externally connected to the proposed power integrated circuit. A secondary cell, a fuel cell, or a solar cell may be used as the DC power source. Reference numeral 4 in FIG. 43 denotes a motor load. The motor may be an induction motor, a permanent magnet motor, or a brushless DC motor.

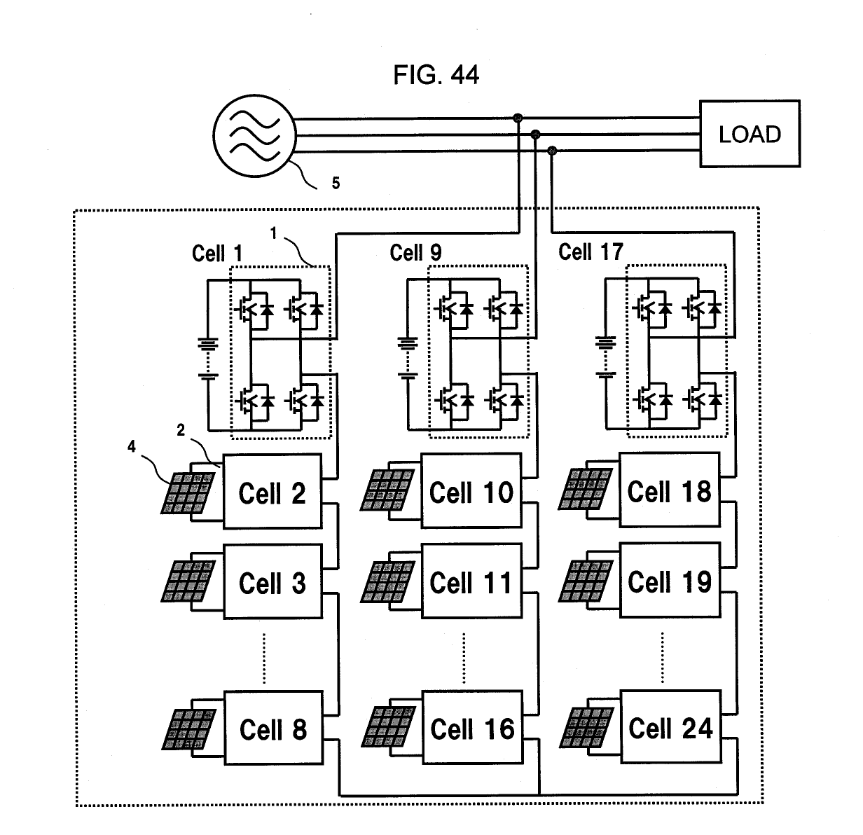

FIG. 44 is a circuit for the case where the proposed power integrated circuit is applied to photovoltaic power generation for system connected operation. Reference numeral 4 in FIG. 44 denotes a solar cell which replaces the DC power source 3 shown in FIG. 43. Reference numeral 5 in FIG. 44 denotes a 100-V or 200-V power distribution system. Other than such a power distribution system, the proposed power integrated circuit can be applied to motors of a few kW or less used in home appliances, charging power supply circuits for hybrid automobiles, PC power supplies (AC adaptors) of several hundreds W, and distributed power supplies. Since the output waveform of the proposed power integrated circuit is a sinusoidal wave containing no harmonic, the power integrated circuit does not require an output filter in the applications shown in FIGS. 43 and 44, and other applications.

A specific embodiment will be described. A 500-W power integrated circuit is designed for the motor load shown in FIG. 43. There will be described a fabrication procedure for the case where the converter specifications determined in Step 4 of FIG. 42 are such that capacity: 500 W; input DC voltage: 150 V; output AC voltage: 100 V; the number of levels: 17; and frequency: 20 kHz.

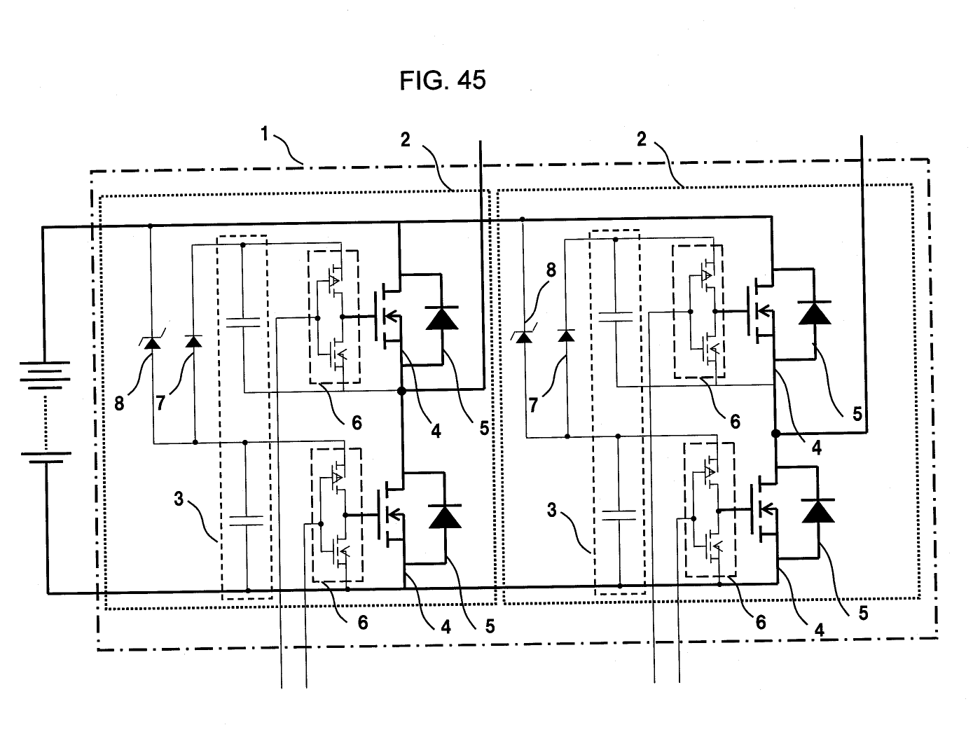

FIG. 45 shows the details of the basic unit 1 of FIG. 43. Reference numeral 1 in FIG. 45 denotes the basic unit shown in FIG. 43. Reference numeral 2 in FIG. 45 denotes a conversion circuit section to be integrated. Reference numeral 3 in FIG. 45 denotes capacitors connected to a drive power source, which capacitors are passive components for a power source designed in Steps 13 to 16 of FIG. 42. Reference numeral 4 in FIG. 45 denotes a power MOSFET, and reference numeral 5 in FIG. 45 denotes an inverse-parallel diode. Reference numeral 6 in FIG. 45 denotes gate driver CMOS devices, and reference numeral 7 in FIG. 45 denotes a diode for supplying energy to the power source so as to drive the high-voltage-side MOSFET. Reference numeral 8 in FIG. 45 denotes a Zener diode for supplying energy from an externally connected DC power source to the drive power source and maintains the required voltage. The withstanding voltage of the basic unit determined in Step 5 of FIG. 42 is assumed to be 30 V, and the rated current of the basic unit determined in Step 5 of FIG. 42 is assumed to be 5 A.

The rated gate voltage of the gate driver device determined in Step 6 of FIG. 42 is assumed to be 10 V, and the withstanding voltage of the gate driver device determined in Step 6 of FIG. 42 is assumed to be 20 V. The material selected in Step 7 of FIG. 42 is assumed to be Si. The on resistance of the basic unit at the withstanding voltage of 30 V is 0.1 mΩcm². When the rated current is 5 A, the device loss is 2.5 mWcm². When the chip area is 1 mm², the generated heat is 250 mW, and the heat generation density is 25 W/cm². When operation at a high temperature of 150° C. is assumed, cooling is possible, and therefore, the engineer makes a Yes determination in Step 9. Each MOSFET in FIG. 45 has a chip area of 1 mm². Since the circuit shown in FIG. 43 includes 96 MOSFETs, the total area of the MOSFETs becomes 0.96 cm².

In Step 10 of FIG. 42, dielectric separation is selected as an insulating scheme. Since an oxide film (SiO₂) typically has an insulating property of 3 MV/cm (30 V/100 nm), the thickness of the oxide film is set to 2 um so as to insulate the DC input voltage of 150 V. Since the oxygen film can have a thickness of 5 to 10 um at the greatest, the engineer makes a Yes determination at Step 12 of FIG. 42.

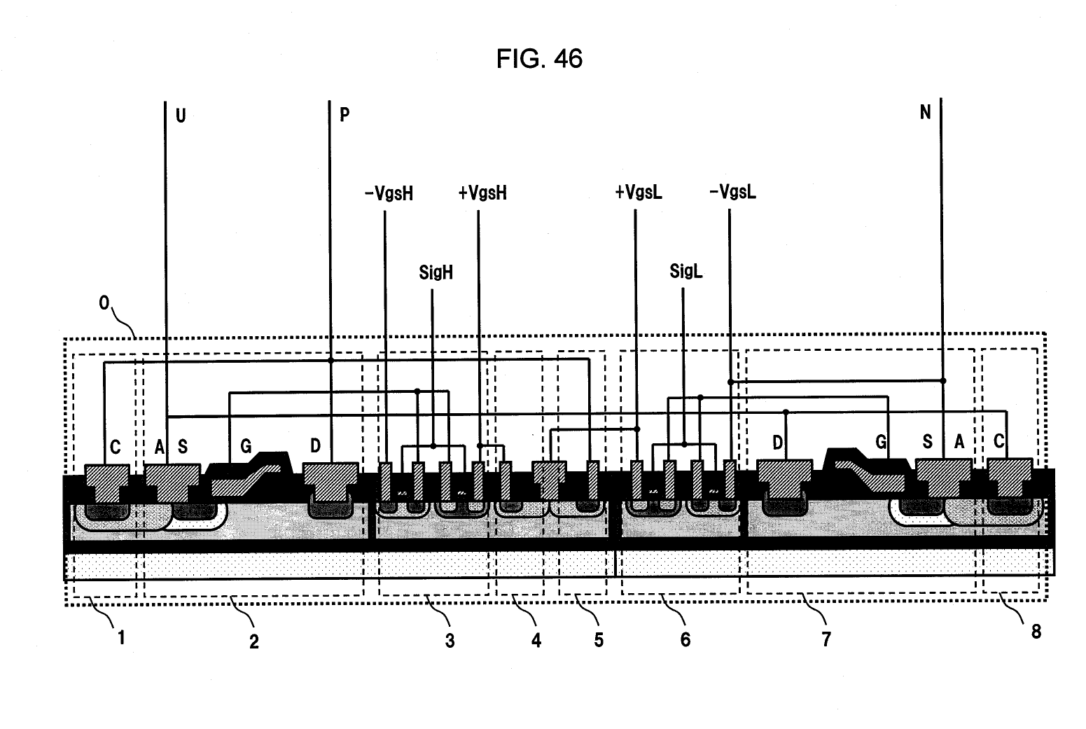

FIG. 46 is a cross sectional view of the integrated basic unit conversion circuit section indicated by reference numeral 2 in FIG. 45. Reference numeral 1 in FIG. 46 denotes the high-voltage-side inverse-parallel diode 5 in FIG. 45, and reference numeral 2 in FIG. 46 denotes the high-voltage-side MOSFET 4 in FIG. 45. Reference numeral 3 in FIG. 46 denotes the high-voltage-side gate drive CMOS device 6 in FIG. 45, and reference numeral 4 in FIG. 46 denotes the high-voltage-side power supply diode 7 in FIG. 45. Reference numeral 5 in FIG. 46 denotes the Zener diode 8 in FIG. 45, and reference numeral 6 in FIG. 46 denotes the low-voltage-side gate drive CMOS device 6 in FIG. 45. Reference numeral 7 in FIG. 46 denotes the low-voltage-side MOSFET 4 in FIG. 45, and reference numeral 8 in FIG. 46 denotes the low-voltage-side inverse-parallel diode 5 in FIG. 45.

In Step 13 of FIG. 42, the engineer calculates the required capacity of the capacitors, which are passive components for the power source. When the input capacitance of each MOSFET 4 in FIG. 45 is assumed to be 1 nF, the power consumption becomes 1 mW when the gate voltage is 10 V and the frequency is 20 kHz. The capacitance determined in Step 14 becomes 10 nF under the assumption that variation of the gate power source voltage is 10%. It is assumed that a ferroelectric substance (relative dielectric constant: about 100) such as barium titanate is used as a dielectric material.

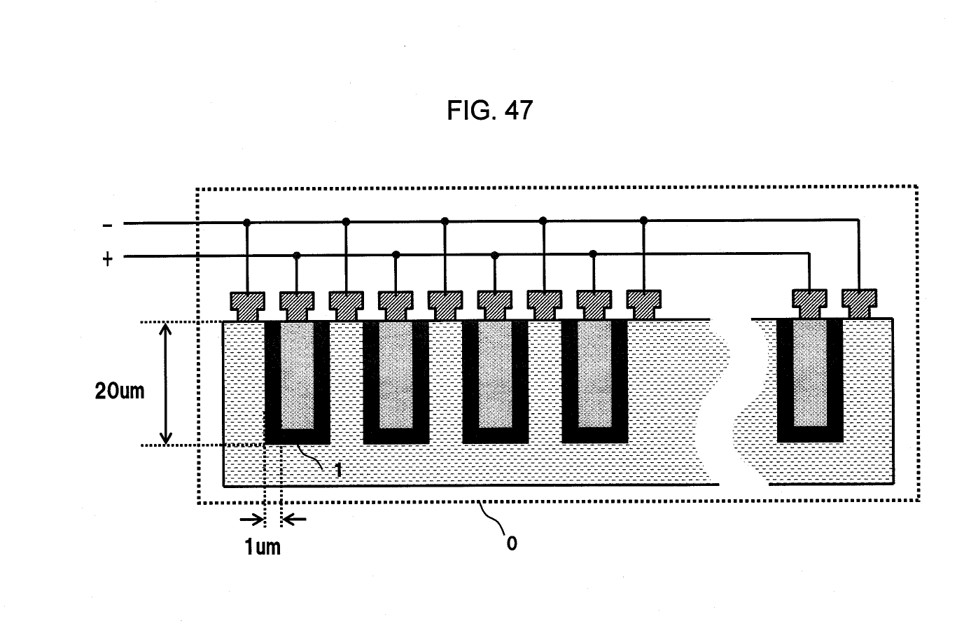

FIG. 47 shows a structure for realizing a capacitance of 10 nF for the drive power source. Reference numeral 0 in FIG. 47 denotes the element 6 in FIG. 45. Reference numeral 1 in FIG. 47 denotes a dielectric material embedding region in a Si substrate. The dielectric material for the capacitance is a ferroelectric substance such as barium titanate. The dielectric material is assumed to have a relative dielectric constant of 100. The capacitance of 10 nF can be formed by arranging trench capacitors each having a width of 1 um and a depth of 20 um in an area of 1 mm².

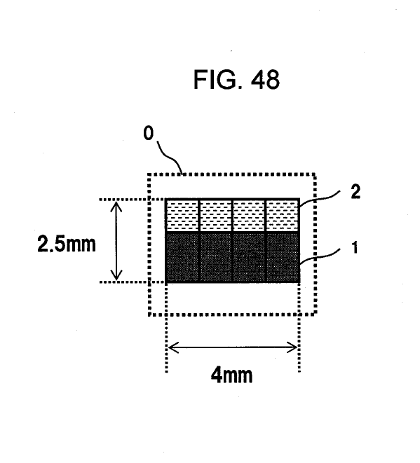

FIG. 48 shows the chip image of the basic unit of the proposed power integrated circuit of FIG. 45. Reference numeral 0 in FIG. 48 denotes the basic unit shown in FIG. 45, and reference numeral 1 in FIG. 48 denotes the basic unit 1 in FIG. 45 from which the capacitors 3 in FIG. 45 is removed. Reference numeral 2 in FIG. 48 denotes a capacitor for the power supply of FIG. 47. The basic unit shown in FIG. 47 is fabricated monolithically. Further, a harmonic suppressing LC filter of a small capacity is added to the multi-level converter so as to reduce the number of levels to thereby reduce the load of semiconductor devices. Thus, it becomes possible to monolithically integrate the conversion circuit. Further, since the power source circuit is integrally provided on the chip, the number of wiring lines extending to the outside of the chip can be reduced, whereby the degree of integration can be improved.

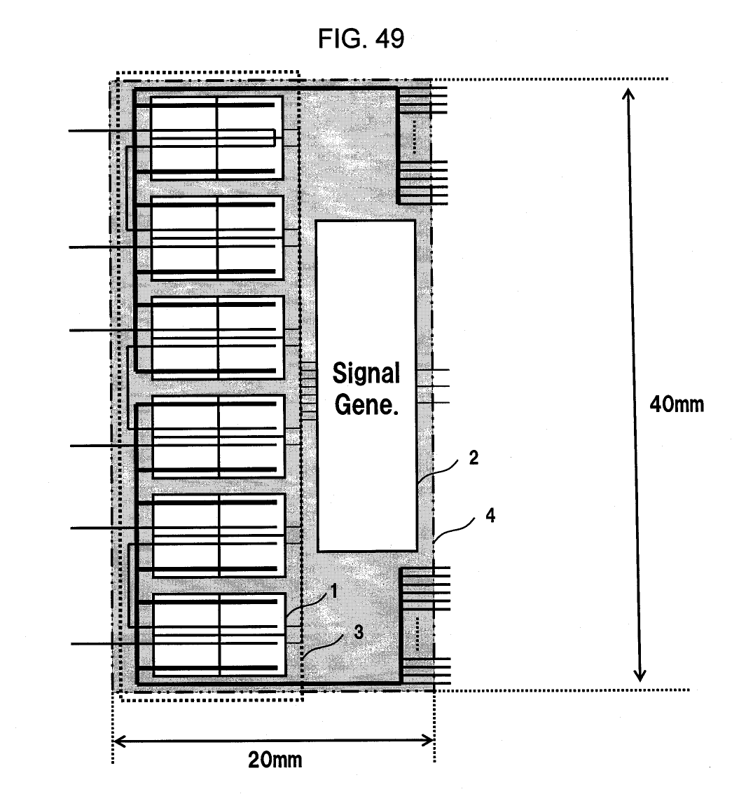

FIG. 49 shows a converter for driving a 500-W motor which is formed by connecting a plurality of chips each having the structure of FIG. 48. In the converter shown in FIG. 48, the basic units are connected in parallel, and PWM phase shift control is employed so as to reduce the load of the semiconductor devices and enable integration. Reference 1 in FIG. 49 denotes the basic unit chip shown in FIG. 48, and reference 2 in FIG. 49 denotes a gate-signal generation IC. From the viewpoint of heat generation density of the element, the converter shown in FIG. 49 employs a multi-chip configuration. Further, through reduction of element resistances and optimal design of high-temperature operation, number of levels, and frequency, the area 3 or 4 of FIG. 49 can be monolithically integrated. A converter having an arbitrary capacity can be realized by connecting the basic units in series and in parallel in a monolithic structure or a multi-chip structure.

What is claimed is:

1. A power integrated circuit including a voltage-type single-phase full-bridge conversion circuit as a basic unit, wherein
the basic unit has two AC terminals, one AC terminal serving as an output terminal and the other AC terminal serving as a ground terminal, and two DC terminals, one DC terminal being a positive terminal, and the other DC terminal being a negative terminal; and
the basic unit has a level-shift-type gate drive circuit configured such that when a low-voltage-side gate drive circuit is on, gate drive energy is stored in a high-voltage-side external gate capacitor via a diode, and when a high-voltage-side gate drive circuit is on, the drive energy stored in the high-voltage-side gate capacitor is supplied to the high-voltage-side gate drive circuit, and wherein
the basic unit is used as an integrated single-phase 3-level conversion circuit;
when the number m of conversion levels is an odd number, three integrated single-phase odd-number-m-level conversion circuits are connected in parallel to thereby form an integrated three-phase odd-number-m-level conversion circuit, wherein each integrated single-phase odd-number-m-level conversion circuit is formed by serially connecting the AC terminals of first through (m−1)/2-th basic units; and
when the number m of conversion levels is an even number, three integrated single-phase even-number-m-level conversion circuits are connected in parallel to thereby form an integrated three-phase even-number-m-level conversion circuit, wherein each integrated single-phase even-number-m-level conversion circuit is formed by serially connecting the AC terminals of first through m/2-th basic units.

2. A power integrated circuit according to claim 1, wherein the output terminal of the first basic unit and the ground terminal of the second basic unit are connected in series to thereby form an integrated single-phase 4-level/5-level conversion circuit; the output terminal of the first basic unit and the ground terminal of the second basic unit are connected in series and the output terminal of the second basic unit and the ground terminal of the third basic unit are connected in series to thereby form an integrated single-phase 6-level/7-level conversion circuit; when m is an odd number, the AC terminals of the first through (m−1)/2-th basic units are connected in series to thereby form an integrated single-phase odd-number-m-level conversion circuit; or when m is an even number, the AC terminals of the first through m/2-th basic units are connected in series to thereby form an integrated single-phase even-number-m-level conversion circuit.

3. A power integrated circuit according to claim 2, wherein three of the basic units are connected in parallel to thereby form an integrated three-phase 3-level conversion circuit; three of the integrated single-phase 4-level/5-level conversion circuits are connected in parallel to thereby form an integrated three-phase 4-level/5-level conversion circuit; three of the integrated single-phase odd-number-m-level conversion circuits are connected in parallel to thereby form an integrated three-phase odd-number-m-level conversion circuit; or three of the integrated single-phase even-number-m-level conversion circuits are connected in parallel to thereby form an integrated three-phase even-number-m-level conversion circuit.

4. A power integrated circuit according to claim 1, wherein two of the integrated three-phase odd-number-m-level conversion circuits are symmetrically connected via a DC section which includes a first DC-link capacitor connected between commonly connected positive and negative terminals of the first basic units for each phase of the two conversion circuits, a second DC-link capacitor connected between commonly connected positive and negative terminals of the second basic units for each phase of the two conversion circuits, and a (m−1)/2-th DC-link capacitor connected between commonly connected positive and negative terminals of the (m−1)/2-th basic units for each phase of the two conversion circuits, to thereby form an integrated three-phase odd-number-m-level AC-DC-AC conversion circuit; or two of the integrated three-phase even-number-m-level conversion circuits are symmetrically connected via a DC section which includes a first DC-link capacitor connected between commonly connected positive and negative terminals of the first basic units for each phase of the two conversion circuits, a second DC-link capacitor connected between commonly connected positive and negative terminals of the second basic units for each phase of the two conversion circuits, and a m/2-th DC-link capacitor connected between commonly connected positive and negative terminals of the m/2-th basic units for each phase of the two conversion circuits, to thereby form an integrated three-phase even-number-m-level AC-DC-AC conversion circuit.

5. A power integrated circuit according to claim 2, wherein two of the integrated single-phase odd-number-m-level conversion circuits are symmetrically connected via a DC section which includes first through (m−1)/2-th DC-link capacitors connected between positive and negative terminals of the first through (m−1)/2-th basic units of the two conversion circuits, to thereby form an integrated single-phase odd-number-m-level AC-DC-AC conversion circuit; or two of the integrated single-phase even-number-m-level conversion circuits are symmetrically connected via a DC section which includes first through m/2-th DC-link capacitors connected between positive and negative terminals of the first through m/2-th basic units of the two conversion circuits, to thereby form an integrated single-phase even-number-m-level AC-DC-AC conversion circuit.

6. A power integrated circuit according to claim 1, wherein high-voltage-side gate drive circuits of the first basic units for each phase share a first DC power source; positive terminals or negative terminals of the high-voltage-side gate drive circuits of the first basic units are formed as common terminals; high-voltage-side gate drive circuits of the second basic units for each phase share a second DC power source; positive terminals or negative terminals of the high-voltage-side gate drive circuits of the second basic units are formed as common terminals; high-voltage-side gate drive circuits of the odd-number-(m−1)/2-th basic units for each phase share an odd-number-(m−1)/2-th DC power source; positive terminals or negative terminals of the high-voltage-side gate drive circuits of the odd-number-(m−1)/2-th basic units are formed as common terminals; high-voltage-side gate drive circuits of the even-number-m/2-th basic units for each phase share an even-number-m/2-th DC power source; positive terminals or negative terminals of the high-voltage-side gate drive circuits of the even-number-m/2-th basic units are formed as common terminals; and, for low-voltage-side drive circuits, positive terminals or negative terminals of the odd-number-(m−1)/2-th basic units for each phase or the even-number-m/2-th basic units for each phase are similarly formed as common terminals to thereby reduce wiring.

7. A power integrated circuit according to claim 6, wherein positive terminals or negative terminals of the first basic units for each phase are formed as common terminals; positive terminals or negative terminals of the second basic units for each phase are formed as common terminals; positive terminals or negative terminals of the odd-number-(m−1)/2-th basic units for each phase are formed as common terminals; and positive terminals or negative terminals of the even-number-m/2-th basic units for each phase are formed as common terminals to thereby reduce wiring.

8. A power integrated circuit according to claim 7, wherein the integrated multi-level conversion circuit is a diode-clamp-type multi-level conversion circuit; and in accordance with a switching pattern of this diode-clamp-type multi-level conversion circuit, semiconductor devices in upper arms for a single phase or three phases are formed of p-channel MOSFETs, and semiconductor devices in lower arms for the single phase or three phases are formed of n-channel MOSFETs, to thereby half the number of gate drive circuits.

9. A power integrated circuit according to claim 1, wherein a converter of an arbitrary capacity is realized by connecting the basic units in series and in parallel in a monolithic structure or a multi-chip structure.

10. A power integrated circuit according to claim 1, wherein a power supply circuit for the multi-level converter using the basic units are integrally formed on a chip so as to reduce the number of wiring lies extending outward from the chip, to thereby increase the degree of integration.

11. A power integrated circuit according to claim 1, wherein a harmonic suppressing LC filter of a small capacity is added to the multi-level converter using the basic units so as to reduce the number of levels to thereby reduce load on semiconductor devices, whereby monolithic integration of the conversion circuit is enabled.

12. A power integrated circuit according to claim 1, wherein the basic units are connected in parallel, and PWM phase-shift control is used so as to reduce load on semiconductor devices, to thereby enable integration.
